(19) United States
(12) Patent Application Publication
(10) Pub. No.: US 2025/0146923 A1
(43) Pub. Date: May 8, 2025

(54) FLUORESCENCE AND/OR CHEMILUMINESCENCE DETECTION USING A PORTABLE DETECTOR IN HIGH-PERFORMANCE LIQUID CHROMATOGRAPHY

(71) Applicant: Iowa State University Research Foundation, Inc., Ames, IA (US)

(72) Inventors: Jared L. Anderson, Ames, IA (US); Danial Shamsaei, Ames, IA (US); Shu-An Hsieh, Ames, IA (US); Saxon J. Ryan, Ames, IA (US); Iran Ocana-Rios, Mexico City (MX)

(21) Appl. No.: 18/925,780

(22) Filed: Oct. 24, 2024

Related U.S. Application Data
(60) Provisional application No. 63/592,803, filed on Oct. 24, 2023.

(51) Int. Cl. G01N 15/1434

(52) U.S. Cl. CPC G01N 15/1436

(57) ABSTRACT

Disclosed are methods and kits for high-performance liquid chromatography (HPLC) fluorescence or chemiluminescence detection. Beneficially, the kits are miniaturized, portable, and can provide low-cost instrumentation. The systems disclosed can utilize a smartphone, tablet or similar device to capture emitted fluorescence or chemiluminescence and to analyze the data to provide chromatograms in different detection channels by plotting red, green, and blue color intensities of emitted fluorescence or chemiluminescence versus time. The systems preferably comprise a flow cell capable of withstanding high mobile phase flow rates, a chamber box, and for fluorescence an LED as a light source and fiber optics to transmit emitted fluorescence to a smartphone camera.

### CROSS-REFERENCE TO RELATED APPLICATIONS

This application claims priority under 35 U.S.C. § 119 to provisional application Ser. No. 63/592,803, filed Oct. 24, 2023, herein incorporated by reference in its entirety.

### GRANT REFERENCE

This invention was made with government support under Grant number CHE-2203891 awarded by the National Science Foundation. The government has certain rights in the invention.

### TECHNICAL FIELD

The disclosure relates to a method and kit for miniaturized, portable, and/or low-cost instrumentation for high-performance liquid chromatography (HPLC) fluorescence or chemiluminescence detection. Specifically, a system that utilizes a smartphone or tablet or the like to capture emitted fluorescence or chemiluminescence and to analyze the data to provide chromatograms in different detection channels by plotting red, green, and blue color intensities of emitted fluorescence or chemiluminescence versus time. The system comprises a flow cell capable of withstanding high mobile phase flow rates, a LED as a light source, a chamber box, and fiber optics to transmit emitted fluorescence to a smartphone camera. Systems for chemiluminescence do not require a light source.

The disclosure relates to a method and kit comprising a multi-channel system to determine several fluorescent or chemiluminescent compounds with different excitation wavelengths.

### BACKGROUND

Fluorescence is a form of luminescence in which molecules absorb light of a particular wavelength (the excitation wavelength) and emit light of longer wavelengths (the emission wavelength). Fluorescence detection is one of the most commonly used detection techniques in HPLC due its high specificity and sensitivity. Fluorescence excitation and emission wavelengths are specific for a given molecule, providing advantages over ultraviolet (UV) detectors which respond to nearly all molecules with moderate to strong chromophores. Since fluorescence intensity is often directly proportional to the intensity of the excitation source, fluorescence detectors offer high sensitivity through the use of intense light sources. Most commercially available fluorescence detectors used in HPLC are equipped with a xenon lamp as the excitation source, sophisticated excitation and emission monochromators, optical modules, photodiode array, and a photomultiplier tube. Computers are generally required to control the excitation and emission wavelengths as well as the acquisition and processing of data, limiting portability of the system.

A schematic diagram of conventional fluorescence detection in HPLC is shown in FIG. 2. Conventional fluorescence detection in HPLC comprises several parts, including a xenon lamp, excitation and emission gratings, a flow cell, and a photomultiplier, as shown in FIG. 2. The response of the photomultiplier is transferred to a computer, processed and displayed on a monitor. High dependence on computers for analyzing signals and expensive optical components make the commercial detector bulky and expensive.

Chemiluminescence is a form of luminescence that emits visible radiation resulting from the excitation of a molecule via a chemical reaction. The process by which chemiluminescence is produced is similar to that of photoluminescence (phosphorescence and fluorescence), except that chemiluminescence does not require a light source, which provides the advantage of simplicity in detector design. Additionally, the absence of a light source reduces background noise and leads to improve detection limits.

Conventional chemiluminescence detection requires a post-column reactor that mixes chemiluminescence reagents with analytes eluted from the column. The reacting mixture is directed to a flow cell, and the emitted light is measured using a photodetector, followed by signal processing with a computer. Photomultiplier tubes (PMTs) are the most commonly used conventional photodetectors for measuring chemiluminescent light due to their high sensitivity, but have several drawbacks including that they are expensive, bulky, fragile, temperature dependent, and sensitivity to electromagnetic fields. Additionally, reliance on a computer to process, present, and store data ultimately limits their portability.

An object and/or advantage of this disclosure is providing miniaturized, portable, and/or low-cost instrumentation for HPLC fluorescence detection.

An object and/or advantage of this disclosure is providing miniaturized, portable, and/or low-cost instrumentation for HPLC chemiluminescence detection, while maintaining acceptable sensitivity.

A further object and/or advantage of this disclosure is providing a system that utilizes a smartphone or like device to capture emitted fluorescence and/or chemiluminescence, to control and program imaging conditions for maximum sensitivity and enhanced reproducibility of the signals, and/or analyze the data and generate chromatograms, for example three separate chromatograms in different detection channels by plotting red, green, and blue color intensities of emitted fluorescence and/or chemiluminescence versus time.

A further object and/or advantage of this disclosure is a multi-channel system to determine several fluorescent compounds with different excitation wavelengths.

### BRIEF DESCRIPTION OF THE FIGURES

The following drawings form part of the specification and are included to further demonstrate certain embodiments. In some instances, embodiments can be best understood by referring to the accompanying figures in combination with the detailed description presented herein. The description and accompanying figures may highlight a certain specific example, or a certain embodiment. However, one skilled in the art will understand that portions of the example or embodiment may be used in combination with other examples or embodiments.

FIG. 1 shows a schematic diagram of a system employing a smartphone for fluorescence detection in HPLC.

FIG. 2 shows a schematic diagram for a conventional HPLC fluorescence detection system.

FIGS. 3A, 3B, and 3C show a schematic illustration of an exemplary single-channel device.

FIG. 3A shows an assembled single-channel device comprising a flow cell, an inlet, an outlet, a light source, and fiber optic.

FIG. 3B shows a top-down illustration of an exemplary single-channel flow cell design.

FIG. 3C shows a top-down illustration of a slit plate with a light slit for an LED light source.

FIGS. 4A and 4B show the components and their assembly forming the smartphone-based fluorescence detection system with a single-channel flow cell. FIGS. 4C and 4D show the components and their assembly forming a detection system with a dual-channel flow cell.

FIG. 4A shows a housing unit which holds the single-channel flow cell, inlet and outlet tubing, and LED light source. Also shown in FIG. 4A is the fiber optic cable connecting the housing unit to a connector box and smartphone.

FIG. 4B shows a side view of the assembled system of FIG. 4A.

FIG. 4C shows a housing unit which holds the dual-channel flow cell, inlet and outlet tubing, and LED light sources. Also shown in FIG. 4C is the fiber optic cables connecting the housing unit to a connector box and smartphone.

FIG. 4D shows a side view of the assembled system of FIG. 4C.

FIG. 5A shows a top-down illustration of an exemplary double-channel flow cell design.

FIG. 5B shows a three-dimensional schematic of an exemplary double-channel flow cell design.

FIG. 6 is a schematic illustration of an exemplary workflow of the fluorescence detection system as described herein comprising HPLC, an exemplary single channel flow cell, fiber optic connection from the flow cell to a smartphone, and a smartphone readout of RGB chromatogram.

FIG. 7A shows chromatograms of red, green and blue channels showing the separation of coumarins using an exemplary smartphone-based fluorescence detector.

FIG. 7B shows chromatograms of red, green and blue channels showing the separation of rhodamine B dyes using an exemplary smartphone-based fluorescence detector.

FIG. 8A shows a plot demonstrating changes in peak area relative to the determination of five coumarin dyes using different channel widths in the flow cell. The mixture contained coumarin 120, coumarin 466, coumarin 307, coumarin 153, and coumarin 6.

FIG. 8B shows a plot demonstrating changes in peak width relative to the determination of five coumarin dyes using different channel widths in the flow cell. The mixture contained coumarin 120, coumarin 466, coumarin 307, coumarin 153, and coumarin 6.

FIG. 9A shows plots describing the change in normalized peak area relative to the analysis of five coumarin dyes using different light slit diameters. The mixture contained coumarin 120, coumarin 466, coumarin 307, coumarin 153, and coumarin 6.

FIG. 9B shows plots describing the change in peak width relative to the analysis of five coumarin dyes using different light slit diameters. The mixture contained coumarin 120, coumarin 466, coumarin 307, coumarin 153, and coumarin 6.

FIG. 10A and FIG. 10B show chromatograms demonstrating the separation of coumarin and rhodamine B dyes from three different dye solutions using the double-channel flow cell design.

FIG. 10A shows chromatograms from Channel I of the double-channel flow cell.

FIG. 10B shows chromatograms from Channel II of the double-channel flow cell.

FIG. 11A shows a chromatogram obtained from the separation of coumarin 120, coumarin 466, coumarin 307, coumarin 153, coumarin 6 and rhodamine B using a UV/vis detector set at a detection wavelength of 260 nm.

FIG. 11B shows a chromatogram obtained from the separation of coumarin 120, coumarin 466, coumarin 307, coumarin 153, coumarin 6 and rhodamine B using a double-channel flow cell geometry and smartphone-based fluorescence detection. This chromatogram shows channel I equipped with a 375 nm LED.

FIG. 11C shows a chromatogram obtained from the separation of coumarin 120, coumarin 466, coumarin 307, coumarin 153, coumarin 6 and rhodamine B using a double-channel flow cell geometry and smartphone-based fluorescence detection. This chromatogram shows channel II equipped with a 570 nm LED.

FIG. 12A is a schematic showing the assembly of components (housing, flow cell, flow cell holder, tubing, mixers, and smartphone) that form a smartphone-based chemiluminescence detector.

FIG. 12B shows the assembled smartphone-based chemiluminescence detection system of FIG. 12A.

FIG. 13 shows schematic illustrations for a linear channel flow cell (Model 1), a rectangular chamber flow cell (Model 2), a cylindrical chamber flow cell (Model 3), and a spiral channel flow cell (Model 4).

FIG. 14 is a schematic representation of a linear channel flow cell positioned in relation to a smartphone camera.

FIG. 15 is a schematic representation of an exemplary spiral mixer.

FIG. 16 is a schematic representation of an exemplary spiral mixer.

FIG. 17 is a schematic representation of an exemplary Y-shaped mixer.

FIG. 18 is a schematic diagram depicting a single-mixer configuration of a smartphone-based chemiluminescence detector for HPLC.

FIG. 19 is a schematic diagram depicting a double-mixer configuration of a smartphone-based chemiluminescence detector for HPLC.

FIG. 20 is an overlaid chromatogram based on maximum RGB values obtained from the separation of carbamazepine by HPLC followed by detection by a smartphone-based chemiluminescence detector.

FIG. 21 is an overlaid chromatogram based on average RGB values obtained from the separation of carbamazepine by HPLC followed by detection by a smartphone-based chemiluminescence detector.

FIG. 22 shows overlaid chromatograms of carbamazepine peak across different channels and peak integration using MATLAB software.

FIG. 23 shows images capturing the moment when the signal intensity reached its maximum for four different flow cells.

FIG. 24 is a graph of normalized peak height by mixer design.

FIG. 25 is a graph of peak height (x-axis) by length of flow cell (cm) (y-axis) and inner diameter of the flow cell (mm) (z-axis).

FIG. 26 is a graph of normalized peak height by H₂SO₄ concentration (mmol/L).

FIG. 27 is a graph of normalized peak height by Ce(SO₄)₂ concentration (mmol/L).

FIG. 28 is a graph of normalized peak height by Ru(BPY)₃ concentration (mmol/L).

FIG. 29 shows chromatograms plotted using MATLAB after image processing with varying integration times.

FIG. 30 is a chromatogram using MATLAB after image processing with varying integration times illustrating the background noise of chromatograms obtained under various conditions.

### DETAILED DESCRIPTION

The present disclosure is not to be limited to that described herein. Mechanical, optical, electrical, chemical, procedural, and/or other changes can be made without departing from the spirit and scope of the present disclosure. No features shown or described are essential to permit basic operation of the present disclosure unless otherwise indicated.

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

Unless defined otherwise, all technical and scientific terms used above have the same meaning as commonly understood by one of ordinary skill in the art to which embodiments of the present disclosure pertain.

It is to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Thus, for example, reference to “a cell” includes a single cell, as well as two or more cells. Similarly, the word “or” is intended to include “and” unless the context clearly indicate otherwise. The word “or” means any one member of a particular list and also includes any combination of members of that list. Further, all units, prefixes, and symbols may be denoted in its SI accepted form.

Numeric ranges recited within the specification are inclusive of the numbers defining the range and include each integer within the defined range. Throughout this disclosure, various embodiments of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

The term “about,” as used herein, refers to variations in size, distance or any other types of measurements that can be resulted from the inherent heterogeneous nature of the measured objects and imprecise nature of the measurements themselves. The term “about” also encompasses variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods, and the like. The term “about” also encompasses amounts that differ due to different equilibrium conditions for a composition resulting from a particular initial mixture. Whether or not modified by the term “about”, the claims include equivalents to the quantities.

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

### Fluorescence Detection

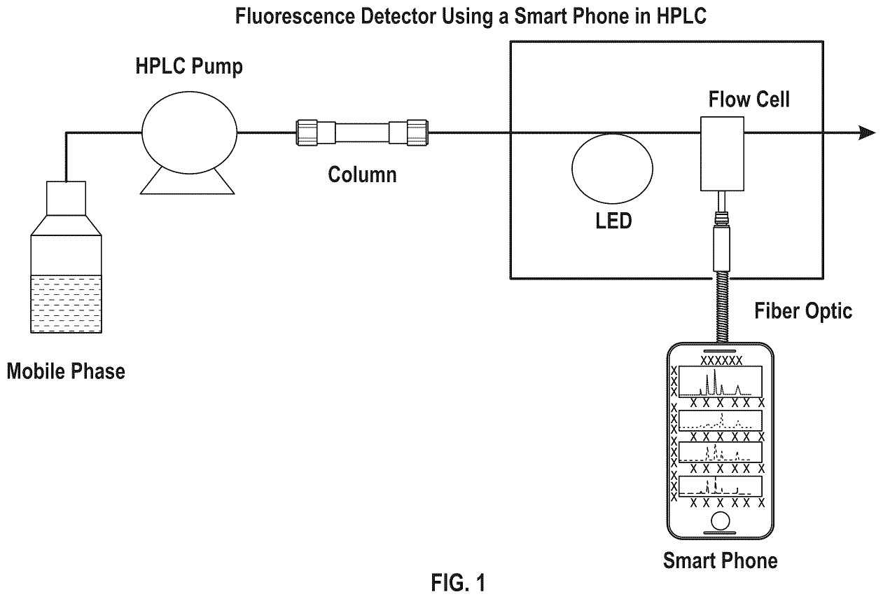

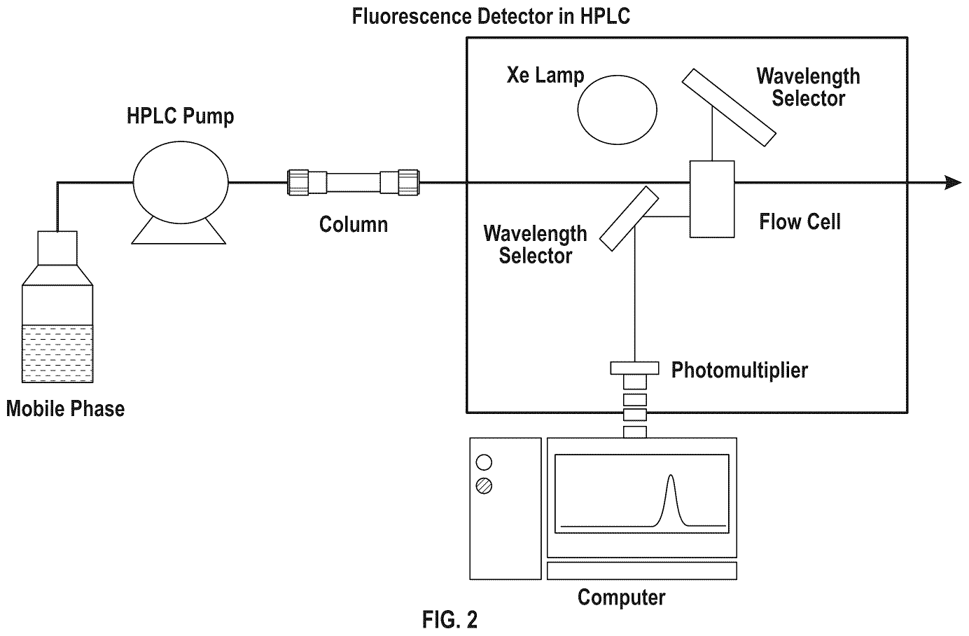

An exemplary embodiment of fluorescence detection is shown in FIG. 1. Molecules are separated through the HPLC column and transferred to the flow cell by the flowing mobile phase in a tubing. The flow cell comprises an inlet, an outlet, and a position for inserting a fiber optic. In this exemplary embodiment, an LED light source is located under the flow cell. The LED has a specific wavelength used as the excitation light for fluorescence to occur. When the mobile phase enters the flow cell, a fluorescent molecule passes over the LED and is excited by the LED light resulting in the production of fluorescent light. The fiber optic transfers the fluorescent light to the smartphone's camera. The smartphone records video from the light, capturing the emitted fluorescence. A smartphone application can then analyze the video, for example by processing the signal and presenting the intensity of light based on red-blue-green (RGB) as chromatograms. FIG. 6 shows a schematic illustration of an exemplary workflow of the fluorescence detection system as described herein.

### Flow Cell

In an embodiment, the flow cell comprises at least one channel. In an embodiment, each channel has an inlet and an outlet configured for a mobile phase to enter the channel through the inlet and exit the channel through the outlet. The flow cell can be comprised of any material as known in the art that will be compatible with the mobile phase and able to sufficiently transfer light into the channel. In an embodiment, the flow cell is comprised of glass, polymethyl methacrylate (PMMA), polycarbonate, polyethylene terephthalate glycol (PETG), Polysulfone (PSU), polyetherimide (PEI), and polyvinylidene fluoride (PVDF), and/or polyvinyl chloride. In a preferred embodiment, the flow cell is comprised of PMMA.

The flow cell can be any size or shape. For convenience, portability, and cost savings, exemplary flow cells are economical in size. In an embodiment, the flow cell is rectangular in shape with flat surfaces. However, the flow cell may have rounded edges, may be circular, can be small enough for only a single channel, or could be large enough to accommodate as many channels as are desired. In an embodiment, the flow cell comprises a rectangular top-down shape with a length and/or width of from about 20 mm to about 100 mm, or from about 30 mm to about 60 mm.

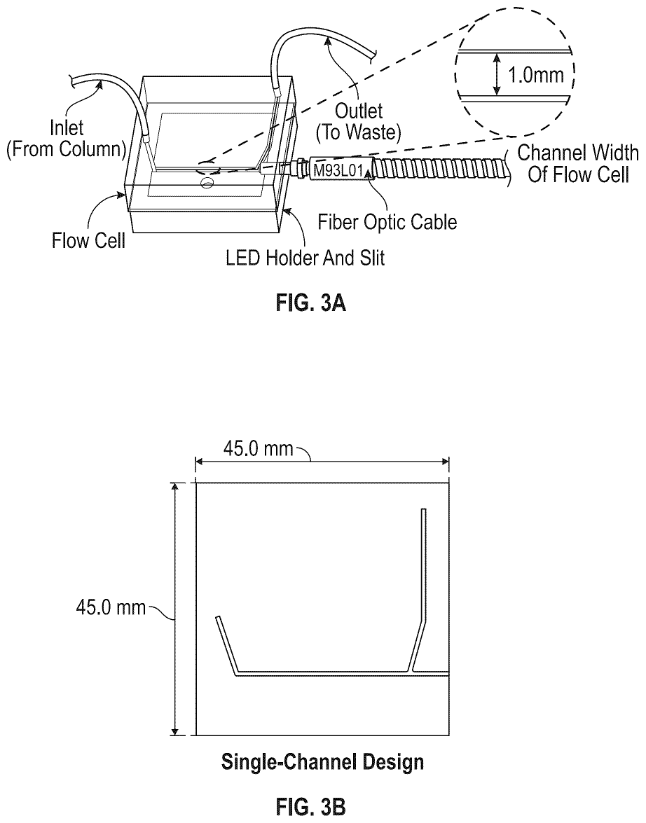

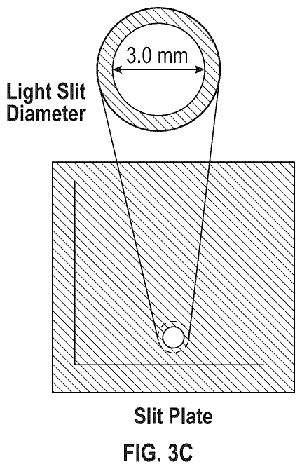

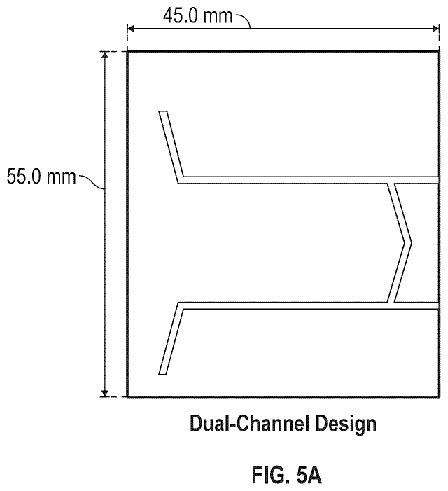

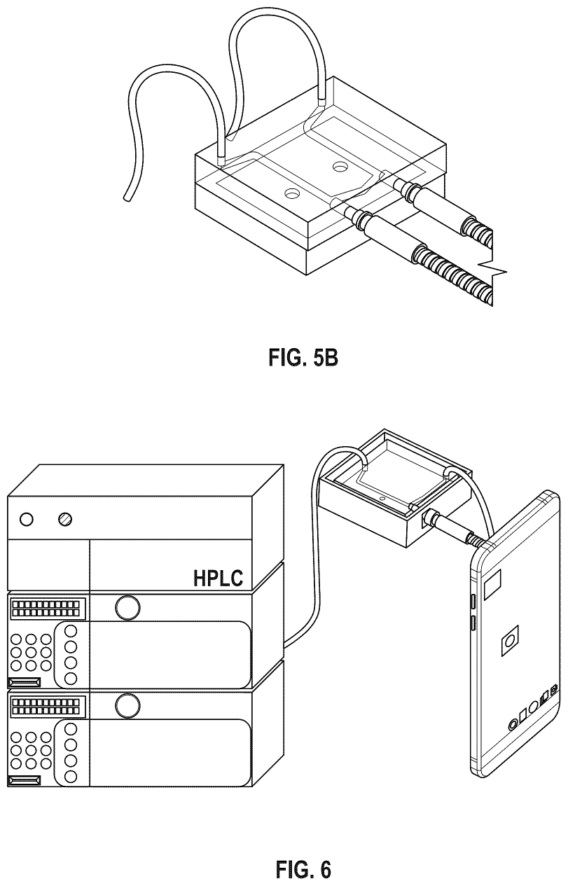

Exemplary single-channel flow cells are shown in FIGS. 3A and 3B. Exemplary dual-channel flow cells are down in FIGS. 5A and 5B. In an embodiment, the channel has any size or dimension to accommodate a laminar flow of a mobile phase. The channel may be straight or curved. In an embodiment, the width of a channel is from about to about 0.5 mm to about 5 mm, or from about 2 mm to about 5 mm, or about 3 mm. The cross-section of a channel can have any two-dimensional shape, such as square, rectangular, circle, or a combination thereof. The length of a channel can be any length as allowed by the dimensions of a flow cell.

In an embodiment, more than one channel is connected in series or in parallel with at least one other channel. In an embodiment, more than one channel is connected in series or in parallel with at least one other channel, in fluid connection with the same or distinct inlet(s) and/or outlet(s). In an embodiment, a number of channels may be grouped together and connected fluidly with another group or groups of channels. Within each group of channels any two channels can be parallel to each other, on top of each other, or in another arrangement. A group of channels may be in fluid connection with a singular inlet or many inlets. A group of channels may be in fluid connection with a singular outlet or many outlets.

In an embodiment, the channel inlet is in fluid connection with an HPLC column output, for example by tubing. In an embodiment, the channel outlet is in fluid connection with a waste receptacle and/or further processing or analysis entities.

In an embodiment, the flow cell comprises at least one light-emitting diode (LED) light source. As used herein “LED” refers to a semiconductor that converts electrical energy into light energy. The emitted light can depend on the semiconductor material and composition.

In an embodiment, the flow cell comprises more than one LED light source, each with the same or different wavelength. In an embodiment, the flow cell is configured such that at least one channel is exposed to at least one LED light source. In an embodiment, the channel is exposed to at least one LED light source through a slit in a light source holder. In an embodiment the light source holder is configured such that the only portions of the flow cell and/or channel exposed to an LED light source is through a slit. The slit can have any size or shape that allows sufficient exposure of the light source to a channel sufficient to cause excitation of fluorescent molecules. In an embodiment, the slit is round or circular in shape. In an embodiment, the slit has a length, width, or diameter of from about 1 mm to about 10 mm, or from about 2 mm to about 5 mm, or of about 3 mm.

In an embodiment, the flow cell comprises more than one channel, wherein each channel is configured for exposure to a separate LED light source. In an embodiment, the flow cell comprises more than one channel, wherein at least two channels are configured for exposure to the same LED light source.

In an embodiment, the LED light source comprises a single wavelength. In an embodiment, the LED light source comprises more than one wavelength. In an embodiment, at least one LED light source is programmable and/or tunable and/or variable, wherein the wavelength of a single LED light source may be determined and/or varied by a person or a system or a controller.

In an embodiment, an LED light source comprises a wavelength from about 240 nm to about 950 nm. In an embodiment, the light source comprises a wavelength of from about 360 nm to about 645 nm.

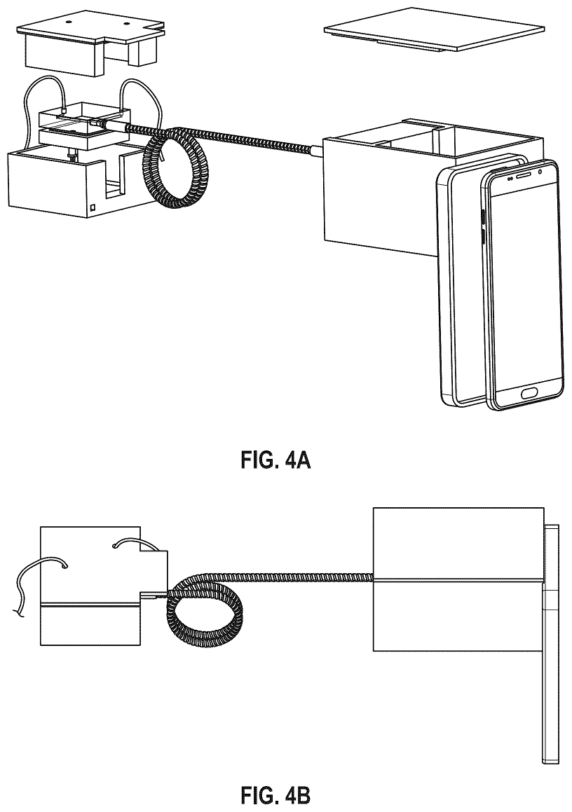

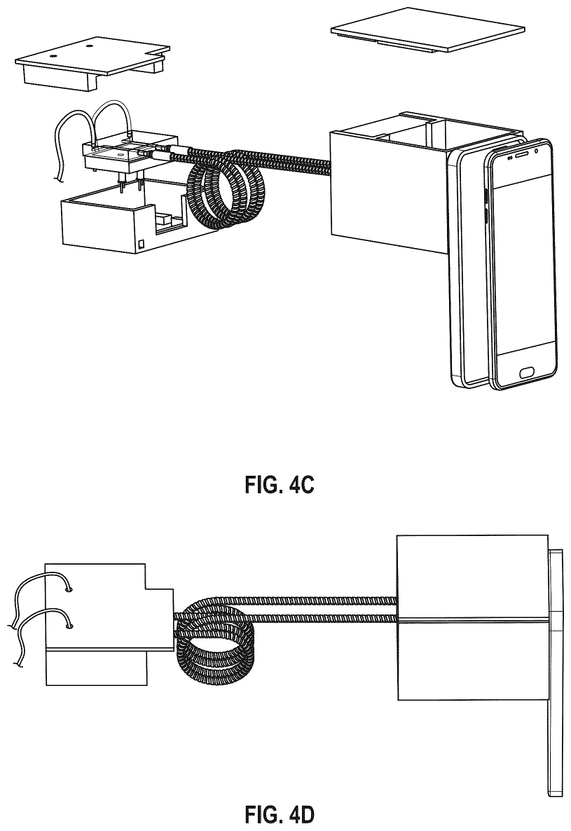

In an embodiment, the fluorescence detection comprises a housing unit configured to enclose the flow cell. In an embodiment the flow cell is partially or completely enclosed in said housing unit. Exemplary housing units are shown in FIG. 4A-FIG. 4D. The housing unit can be any size or shape such as to accommodate the flow cell. In an embodiment, the housing unit is comprised of a material that is impenetrable to light. In an embodiment, the housing unit is comprised of any material such as plastic or metal or natural material that does not allow light to significantly pass through.

### Portable Detector

To meet the goals of miniaturizing components and reducing the costs of chemical analysis, a smartphone has been selected for use as a portable detector in embodiments of the fluorescence detection system described herein. As used herein “smartphone” refers to a mobile phone that performs many of the functions of a computer, typically having a touchscreen, internet access, and an operating system capable of running downloaded applications. Smartphones typically employ fast, multi-core processors that enable rapid signal processing while also offering features including but not limited to high-capacity memory, long battery lifetimes, and high-quality cameras which are important features of a portable detector. The portable detector for use herein should be able to detect fluorescence signal under the conditions of a flowing mobile phase and capture and/or record emitted fluorescence with high sensitivity.

In an embodiment, the portable detector comprises a video camera and/or recorder. In an embodiment, the portable detector records video for later analysis. In an embodiment, the portable detector records video and also processes the signal and presents the intensity of light based on red-blue-green (RGB) as chromatograms. In an embodiment the portable detector comprises a smartphone, tablet, video camera, image sensor, video recorder, and/or laptop; it should be understood that the portable detector can include a controller, processing device or other computer, such as a smart phone or laptop; however, this disclosure also encompasses portable detectors that are in optical, wireless, or wired communication with a controller or processing device such as an Arduino, raspberry pi, or similar device.

In an embodiment, a fiber optic cable is positioned to capture emitted light from a mobile phase as it passes by a light source. An exemplary embodiment of a fiber optic cable positioned to capture emitted light from a mobile phase in a single channel is shown in FIG. 3A In an embodiment, a flow cell comprises more than one channel and more than one fiber optic cable, wherein each fiber optic cable is positioned to capture emitted fluorescence from a separate channel. As exemplary embodiment of two fiber optic cables positioned to capture emitted fluorescence from two separate channels is shown in FIG. 5B.

In an embodiment, a portable detector is configured to capture a signal from the fiber optic cable as shown in exemplary FIG. 6. In an embodiment, the portable detector is positioned as close to the fiber optic cable that allows adequate focus of the detector's camera. In an embodiment, the portable detector is positioned from the fiber optic cable the distance of the camera lens's focal length. In an embodiment, the portable detector is positioned from about 4 mm to about 10 mm, or from about 5 mm to about 7 mm, from the fiber optic cable.

In an embodiment, the fiber optic cable connects to a connector box, wherein the connector box is configured to isolate the portable detector from surrounding light. The connector box can be any convenient shape or size. In an embodiment, the connector box is comprised of a material that is impenetrable to light. In an embodiment, the connector box is comprised of any material such as plastic or metal or natural material that does not allow light to significantly pass through. In an embodiment, the connector box is configured to fix the distance and angle of the camera with respect to the end of the fiber optic cable.

### Fluorescence Detection Systems and Kits

Disclosed herein is a kit comprising any flow cell as disclosed herein and at least one fiber optic cable. Disclosed herein is a kit comprising any flow cell as disclosed herein, any housing unit as described herein, and at least one fiber optic cable. Disclosed herein is a kit comprising any flow cell as disclosed herein, at least one fiber optic cable, and any connector box as described herein. Disclosed herein is a kit comprising any flow cell as disclosed herein, any housing unit as described herein, at least one fiber optic cable, and any connector box as described herein. Such kits may be in separate pieces, partly assembled, or assembled.

Disclosed herein is a fluorescence detection system comprising any flow cell as disclosed herein, at least one fiber optic cable, and at least one portable detector. Disclosed herein is a fluorescence detection system comprising any flow cell as disclosed herein, any housing unit as described herein, at least one fiber optic cable, and at least one portable detector. Disclosed herein is a fluorescence detection system comprising any flow cell as disclosed herein, at least one fiber optic cable, any connector box as described herein, and at least one portable detector. Disclosed herein is a fluorescence detection system comprising any flow cell as disclosed herein, any housing unit as described herein, at least one fiber optic cable, any connector box as described herein, and at least one portable detector.

### Methods of Fluorescence Detection

Disclosed herein is a method of fluorescence detection comprising flow of a mobile phase through at least one channel of a flow cell of any fluorescence detection system as described herein and capturing the emitted light with a portable detector. As used herein, “mobile phase” refers to a liquid comprising one or more target compounds dissolved in a solvent that has passed through an HPLC column wherein the compounds contained in the liquid are separated. In an embodiment, the portable detector records video of the emitted light.

In an embodiment, the method comprises laminar flow of the mobile phase through a flow cell channel, from the inlet to the outlet. In an embodiment, the uniform flow is ensured by any means as known in the art, for example a pump at an inlet and/or a pump at an outlet. In an embodiment, the mobile phase has a flow rate of from about 0.5 mL min-1 to about 5 mL min-1, of from about 0.5 mL min-1 to about 2 mL min-1, or of about 1 mL min-1.

In an embodiment, the method further comprises providing chromatograms of color intensities of emitted fluorescence versus time. In an embodiment, the chromatograms comprise red-blue-green chromatograms. In an embodiment, the flow cell comprises more than one channel, wherein separate chromatograms are provided for each channel in a flow cell. In an embodiment, the chromatograms are produced by or on the portable detector. In an embodiment, the portable detector is a smartphone or tablet and comprises an application wherein the captured emitted light is analyzed and chromatograms produced.

### Chemiluminescence Detection

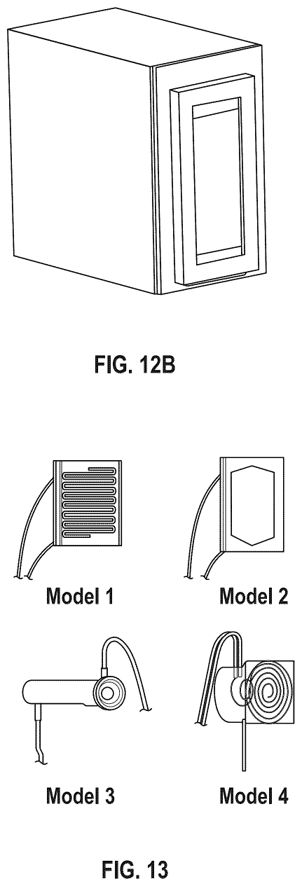

An exemplary embodiment of chemiluminescence detection is shown in FIGS. 12A and 12B. FIG. 12A is a schematic showing the assembly of components (housing, flow cell, flow cell holder, tubing, mixers, and smartphone) that form an exemplary smartphone-based chemiluminescence detector. FIG. 12B shows the assembled smartphone-based chemiluminescence detection system of FIG. 12A.

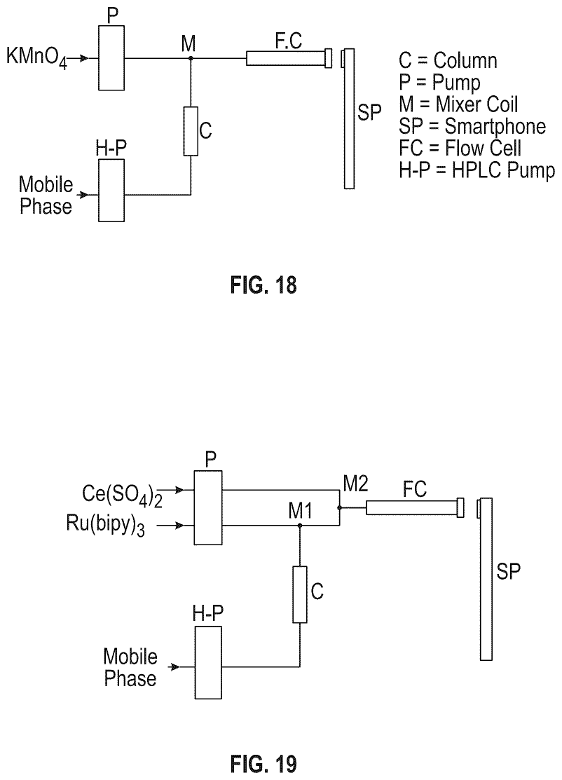

Molecules are separated through the HPLC column. The mobile phase exiting the HPLC column is mixed with one or more reagents in one or more mixers and transferred to the flow cell by tubing. The flow cell comprises an inlet, an outlet, and optionally includes one or more mixers. When the mobile phase comprising the analyte is mixed with one or more reagents, a chemical reaction results in chemiluminescence which is captured by the smartphone's camera. A smartphone application can then analyze the images, for example by processing the signal and presenting the intensity of light based on red-blue-green (RGB) as chromatograms. FIG. 18 shows an exemplary schematic diagram depicting a single-mixer configuration of a smartphone-based chemiluminescence detector for HPLC as described herein. FIG. 19 is a schematic diagram depicting a double-mixer configuration of a smartphone-based chemiluminescence detector for HPLC as described herein.

### Flow Cell and Mixer

In an embodiment, the flow cell comprises at least one inlet and at least one outlet and is configured for a mobile phase mixed with one or more reagents to enter through an inlet and exit through an outlet. The flow cell can be comprised of any material as known in the art that will be compatible with the mobile phase and/or reagents and able to sufficiently transfer light to the detector. In an embodiment, the flow cell is comprised of glass, polymethyl methacrylate (PMMA), polycarbonate, polyethylene terephthalate glycol, Polysulfone (PSU), polyetherimide (PEI), and polyvinylidene fluoride (PVDF), and/or polyvinyl chloride. In a preferred embodiment, the flow cell is comprised of 3D printing resin.

The flow cell can be any size or shape, configured flow or hold the mobile phase mixed with one or more reagents for a period of time suitable for chemiluminescence detection. For convenience, portability, and cost savings, exemplary flow cells are economical in size. The flow cell may have rounded edges or straight edges, may be circular, may be rectangular, may be cylindrical, and the like. In an embodiment, the flow cell comprises a tubular or cylindrical shape with a length of from about 2 cm to about 20 cm, or from about 4 cm to about 14 cm, or greater than about 10 cm, or about 12 cm, and an inner diameter of from about 2.5 mm to about 7.0 mm, or from about 2.5 mm to about 5.5 mm, or about 4.0 mm.

Exemplary flow cells are shown in FIG. 13. In an embodiment, the flow cell comprises at least one channel configured to accommodate a laminar flow of the mobile phase and reagent(s). The channel has any size or dimension to accommodate said laminar flow. The length of a channel can be any length as allowed by the dimensions of a flow cell. The channel may be straight or curved. A channel may comprise turns or angles or alterations in course. The cross-section of a channel can have any two-dimensional shape, such as square, rectangular, circle, or a combination thereof. In an embodiment, the flow cell comprises a chamber of any size or shape. FIG. 13 shows schematic illustrations for an exemplary linear channel flow cell (Model 1), an exemplary rectangular chamber flow cell (Model 2), an exemplary cylindrical chamber flow cell (Model 3), and an exemplary spiral channel flow cell (Model 4).

In an embodiment, a flow cell inlet is in fluid connection with an HPLC column output, for example by tubing. In an embodiment, a flow cell inlet is in fluid connection with the output of a mixer, for example by tubing. In an embodiment, a flow cell outlet is in fluid connection with a waste receptacle and/or further processing or analysis entities.

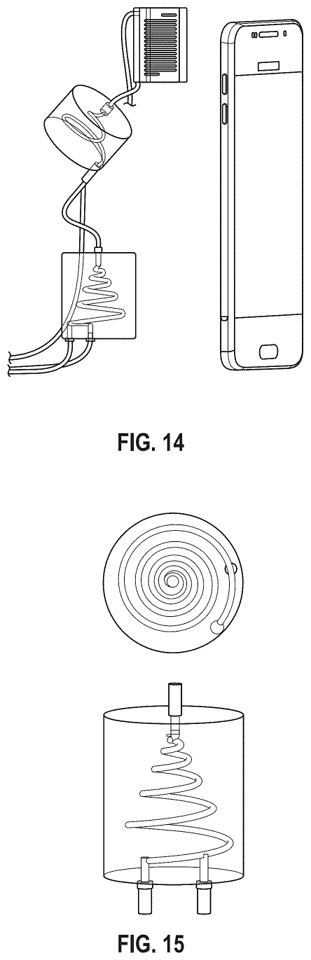

In an embodiment, the chemiluminescence detection comprises at least one mixer configured to mix the mobile phase with one or more reagent. In an embodiment, the chemiluminescence detection comprises one mixer. In an embodiment, the chemiluminescence detection comprises two mixers. In an embodiment, the chemiluminescence detection comprises one mixer for each reagent. An exemplary schematic of chemiluminescence detection with a single mixer is shown in FIG. 18. An exemplary schematic of chemiluminescence detection with two mixers is shown in FIG. 14 and FIG. 19.

In embodiments comprising more than one mixer, the mixers may be configured in series or in parallel. The arrangement and number of mixers within the chemiluminescent detection system depends on the chemiluminescent reaction between the analyte and the reagent.

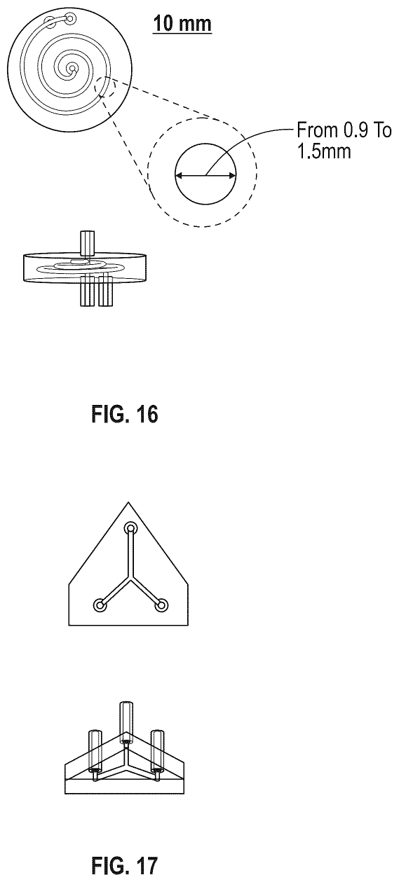

Exemplary mixers are shown in FIGS. 15, 16 and 17. Each figure includes a top-down view and a side view of the mixer. FIG. 15 and FIG. 16 are schematic representations of exemplary spiral mixers configured for the mobile phase to flow through the mixer and at least one reagent to be added to the mobile phase through a separate inlet. FIG. 17 is a schematic representation of an exemplary Y-shaped double mixer, configured for the mobile phase and reagent to be added in separate inlets and removed through an outlet. The mixer may comprise a separate inlet for each reagent, or the same inlet for more than one reagent. In an embodiment, the chemiluminescence detection comprises a spiral mixer, wherein the mixer comprises a spiral channel wherein the mobile phase and reagents are mixed. In an embodiment, the chemiluminescence detection comprises two spiral mixers. An exemplary embodiment comprising two spiral mixers is shown in FIG. 14. In FIG. 14, the chemiluminescence detection is configured so that the mobile phase enters a first mixer configured to add a first reagent, the output of which is directed by tubing to the second mixer which is configured to add a second reagent to the mixture of the mobile phase and the first reagent. The system is then configured to flow the mobile phase and reagents to a flow cell for chemiluminescence detection by a portable detector.

The mixer can be comprised of any material as known in the art that will be compatible with the mobile phase and reagents. The mixer can be any size or shape or configuration suitable to mix the mobile phase with one or more reagent. In an embodiment, the mixer comprises a channel with an inner diameter of from about 0.5 mm to about 3 mm, or from about 0.9 to about 1.5 mm.

In an embodiment, the flow cell comprises a mixer. An exemplary embodiment of a flow cell comprising a spiral mixer is shown in FIG. 13. Model 4. In an embodiment, the flow cell comprises an inlet in fluid connection with an HPLC column output and a separate inlet configured for adding one or more reagents. The flow cell may comprise a separate inlet for each reagent, or the same inlet for more than one reagent.

In an embodiment, the system comprises a flow cell holder configured to hold the flow cell in a stationary position. The holder can have any size or shape and be made of any suitable material.

In an embodiment, the system comprises a housing unit configured to enclose the flow cell. In an embodiment, the housing unit is configured to enclose the flow cell, and the mixer(s). In an embodiment, the housing unit is configured to enclose the flow cell, the flow cell holder, and the mixer(s). In an embodiment the flow cell, flow cell holder, and/or mixer(s) are partially or completely enclosed in said housing unit. In an embodiment, the housing is configured to hold the portable detector stationary. Exemplary housing units are shown in FIG. 12A and FIG. 12B. The housing unit can be any size or shape such as to accommodate the flow cell, flow cell holder, and mixer(s) and/or to hold the portable detector stationary. In an embodiment, the housing unit is comprised of a material that is impenetrable to light. In an embodiment, the housing unit is comprised of any material such as plastic or metal or natural material that does not allow light to significantly pass through.

### Portable Detector

To meet the goals of miniaturizing components and reducing the costs of chemical analysis, a smartphone has been selected for use as a portable detector in embodiments of the chemiluminescence detection system described herein. As used herein “smartphone” refers to a mobile phone that performs many of the functions of a computer, typically having a touchscreen, internet access, and an operating system capable of running downloaded applications. Smartphones typically employ fast, multi-core processors that enable rapid signal processing while also offering features including but not limited to high-capacity memory, long battery lifetimes, and high-quality cameras which are important features of a portable detector. The portable detector for use herein should be able to detect chemiluminescence signal under the conditions of a flowing mobile phase and capture and/or record emitted light with high sensitivity.

In an embodiment, the portable detector comprises a camera. In an embodiment, the portable detector stores the image for later analysis. In an embodiment, the portable detector stores the image and also processes the signal and presents the intensity of light based on red-blue-green (RGB) as chromatograms. In an embodiment the portable detector comprises a smartphone, tablet, camera, video camera, image sensor, and/or laptop; it should be understood that the portable detector can include a controller, processing device or other computer, such as a smart phone or laptop; however, this disclosure also encompasses portable detectors that are in optical, wireless, or wired communication with a controller or processing device such as an Arduino, raspberry pi, or similar device.

### Chemiluminescence Detection Systems and Kits

Disclosed herein is a chemiluminescence kit comprising any flow cell as disclosed herein. Disclosed herein is a kit comprising any flow cell as disclosed herein and any mixer as disclosed herein. Disclosed herein is a kit comprising any flow cell as disclosed herein, any flow cell holder as described herein, and any mixer as described herein. Disclosed herein is a kit comprising any flow cell as disclosed herein, any flow cell holder as described herein, any mixer as described herein, and any housing unit as described herein. Such kits may be in separate pieces, partly assembled, or assembled.

Disclosed herein is a chemiluminescence detection system comprising any flow cell as disclosed herein, and at least one portable detector. Disclosed herein is a chemiluminescence detection system comprising any flow cell as disclosed herein, any mixer as disclosed herein, and at least one portable detector. Disclosed herein is a chemiluminescence detection system comprising any flow cell as disclosed herein, any flow cell holder as described herein, any mixer as described herein, and at least one portable detector. Disclosed herein is a chemiluminescence detection system comprising any flow cell as disclosed herein, any flow cell holder as described herein, any mixer as described herein, any housing unit as described herein, and at least one portable detector. Disclosed herein is a chemiluminescence detection system comprising any flow cell as disclosed herein, any flow cell holder as described herein, and at least one portable detector. Disclosed herein is a chemiluminescence detection system comprising any flow cell as disclosed herein, any flow cell holder as described herein, any housing unit as described herein, and at least one portable detector.

### Methods of Chemiluminescence Detection

Disclosed herein is a method of chemiluminescence detection comprising flowing a mobile phase and at least one reagent through any of the chemiluminescence detection system or kits as described herein and capturing the emitted light with a portable detector. Disclosed herein is a method of chemiluminescence detection comprising flowing a mobile phase and at least one reagent through a flow cell of any chemiluminescence detection system as described herein and capturing the emitted light with a portable detector. As used herein, “mobile phase” refers to a liquid comprising one or more target compounds dissolved in a solvent that has passed through an HPLC column wherein the compounds contained in the liquid are separated. In an embodiment, the portable detector records images or videos of the emitted light.

In a preferred embodiment, the method comprises laminar flow of the mobile phase mixed with at least one reagent through the flow cell, from the inlet to the outlet. In an embodiment, the method comprises laminar flow of the mobile phase through at least one mixer in fluid connection with and a flow cell. In an embodiment, the method comprises laminar flow of at least one reagent through at least one mixer in fluid connection with and a flow cell. In an embodiment, the laminar flow is ensured by any means as known in the art, for example a pump at an inlet and/or a pump at an outlet. In an embodiment, the mobile phase and/or reagent has a flow rate of from about 0.5 mL min-1 to about 5 mL min-1, of from about 0.5 mL min-1 to about 2 mL min-1, or of about 1 mL min-1. While laminar flow is described and preferred, there is the ability to utilize turbulent flow in an alternative preferred embodiment; use of turbulent flow can assist with mixing.

In an embodiment, the method further comprises providing chromatograms of color intensities of emitted chemiluminescence versus time. In an embodiment, the chromatograms comprise red-blue-green chromatograms. In an embodiment, the chromatograms are produced by or on the portable detector. In an embodiment, the portable detector is a smartphone or tablet and comprises an application wherein the captured emitted light is analyzed and chromatograms produced.

### EXAMPLES

Embodiments of the enhancers disclosed herein and their methods of use are further defined in the following non-limiting Examples. It should be understood that these Examples, while indicating one or more preferred embodiments, are given by way of illustration only and are non-limiting. From the above discussion and these Examples, one skilled in the art can ascertain the essential characteristics of the disclosed compositions, and without departing from the spirit and scope thereof, can make various changes and modifications of the embodiments disclosed herein to adapt it to various usages and conditions. Thus, various modifications of the embodiments, in addition to those shown and described herein, will be apparent to those skilled in the art from the foregoing description. Such modifications are also intended to fall within the scope of the appended claims.

### Example 1: Smartphone-Based Fluorescence Detector Coupled to HPLC for the Analysis of Six Fluorescent Dyes

The six fluorescent molecules to be analyzed were five coumarin dyes and a rhodamine B dye. Coumarin 6 (98%), coumarin 153 (99%), coumarin 120 (99%), and rhodamine B (95%) were purchased from Sigma-Aldrich (St. Louis, MO, USA). Coumarin 307 (98%) and coumarin 466 (98%) were obtained from Santa Cruz Biotechnology (Dallas, TX, USA). Acetonitrile (HPLC grade, ≥99%), methanol (HPLC grade, ≥99%) and chloroform (98%) were obtained from Sigma-Aldrich. Deionized water (18.2 MΩ cm) was produced by a Milli-Q water filtration system (Millipore, Bedford, MA, USA). Absorption spectra of all dyes were detected with a NanoDrop 2000c spectrophotometer from Thermo Fisher Scientific (Waltham, MA, USA). Coumarin 6 (500 mg L⁻¹) was prepared in a methanol:acetonitrile solution (50:50, v/v) and all other dyes (500 mg L⁻¹) were prepared in methanol in light-resistant containers and stored at 4° C. Sample solutions were prepared daily by diluting the stock solutions in methanol.

A single-channel flow cell as shown in FIG. 3A and FIG. 3B was fabricated using a computer numerical control (CNC) milling machine using clear polymethyl methacrylate (PMMA). The assembled device as shown in FIG. 3A comprises a flow cell, inlet, outlet, a light source, and fiber optic. A two-dimensional design of the flow cell is shown in FIG. 3B including exemplary dimensions of a flow cell. A schematic illustration of the plate with the light slit and LED is shown in FIG. 3C. FIG. 6 is a schematic illustration of an exemplary workflow as used in the Examples including HPLC, a single channel flow cell, fiber optic connection from the flow cell to a smartphone, and a smartphone readout of RGB chromatograms.

Components and their assembly forming the smartphone-based fluorescence detector is shown in FIG. 4A and FIG. 4B. The schematic in FIG. 4A shows the housing unit which holds the single-channel flow cell, PEEK tubing, an LED holder, and an LED. Also shown in FIG. 4A is the fiber optic cable, a connector box, and a smartphone. FIG. 4B shows a side view of the assembled system. A single-channel flow cell comprised of a fiber optic cable and a monochromatic LED was used. A fiber optic cable was chosen to transfer fluorescent light to the smartphone camera for minimization of noise and signal loss.

Components and their assembly forming the smartphone-based fluorescence detector are also shown in FIG. 4C and FIG. 4D. The schematic in FIG. 4C shows the housing unit which holds the dual-channel flow cell, PEEK tubing, an LED holder, and LEDs. Also shown in FIG. 4C is the fiber optic cables, a connector box, and a smartphone. FIG. 4D shows a side view of the assembled system. A dual-channel flow cell comprised of two fiber optic cables and two monochromatic LEDs was used. fiber optic cables were chosen to transfer fluorescent light to the smartphone camera for minimization of noise and signal loss.

For flow cell fabrication, channels were milled on the surface of 5 mm clear PMMA using a Super Mini Mill machine. Clear PMMA was chosen for construction of the flow cell using a CNC mill, and a mobile phase composed of methanol and water was used throughout the Examples. Flow cell material must be compatible with the solvent and able to sufficiently transfer light into the channel.

Flow cells with different channel widths and a constant channel depth of 1.4 mm were constructed. After milling channel patterns and cutting holes within the top layer, the two layers were bonded together with chloroform.

To direct mobile phase from the HPLC column to the flow cell, PEEK tubing (0.3 mm inner diameter) from Cole-Parmer (Vernon Hills, IL, USA) was used. Collection of fluorescence emitted by the dyes was accomplished using a fiber optic cable purchased from Thorlabs (Newton, NJ, USA) featuring an inner core diameter of 1500 μm that was attached to the flow cell. The emitted fluorescence image was directed to the camera of a Samsung Galaxy S20 smartphone (Suwon-si, South Korea) by connecting the other end of the fiber optic cable to the connector.

Toolbox software was downloaded from Google Play to control video recording conditions and online monitoring of the signal. The software offers different interfaces, and the user interface of Color Picker was utilized to monitor the signal online. Xrecorder software was used to record the smartphone screen. The recorded videos were processed by a MATLAB code. Using screen recording software enabled access to signals at any moment while increasing the speed of video processing by MATLAB code.

The housing, LED holder, light slit plate and connector box were all fabricated by 3D printing using black PLA filament and subsequently assembled.

The connector box functioned to not only isolate the smartphone camera from surrounding light but also fixed the distance and angle of the camera with respect to the end of the fiber optic cable. Connector boxes with varied lengths between the camera and the end of the fiber optic cable were examined. Due to the camera lens's focal length, it was not able to clearly focus on an object at distances less than 7.5 cm. On the other hand, distances greater than 7.5 cm resulted in decreased signal by reducing the amount of emitted light that reaches the camera. Thus, 7.5 cm was selected as an optimal distance between the camera and end of the fiber optic cable. The housing was designed to accommodate the flow cell, slit plate, LED and LED holder, and also prevented light from the surroundings to enter the fiber optic cable and flow cell.

A LED served as the excitation light source and was maintained in the LED holder. An advantage of the design includes easy replacement of the appropriate LED depending on the measured analytes. In this Example, two LEDs (375±20 nm and 570±30 nm) were obtained from Thorlabs and Mouser Electronics (Mansfield, TX, USA), respectively, to enable detection of the coumarin and rhodamine B dyes, respectively. The light slit plate was placed between the flow cell and LED holder to control the amount of light that reaches the flow cell as well as to minimize chromatographic band broadening. Since the emission intensity of the LED depends on the applied voltage, constant voltage was applied to each LED using a Jesverty adjustable direct current power supply obtained from Amazon (Seattle, WA, USA).

To optimize channel width and light slit diameter, a mixture of the five coumarin dyes: coumarin 120 (1.0 mg L-1), coumarin 466 (1.5 mg L-1), coumarin 307 (2.0 mg L-1), coumarin 153 (6.0 mg L-1) and coumarin 6 (3.0 mg L-1) were selected since they can be readily separated using reverse phase HPLC.

Chromatographic separations were carried out on a Shimadzu LC-20A HPLC (Tokyo, Japan) with a Rheodyne manual injector featuring a 20 μL sample loop. Separations were performed using a Restek Ultra C18 analytical column (250 mm×4.6 mm i.d., 5 μm particle size) obtained from Restek Corporation (Bellefonte, PA, USA) at room temperature under isocratic mode using a methanol:water (90:10, v/v) mobile phase with a constant flow rate of 1 mL min-1. The mobile phase was first directed through a UV detector set at detection wavelengths of 235 nm and 260 nm and then entered the flow cell equipped with smartphone detection and finally to waste.

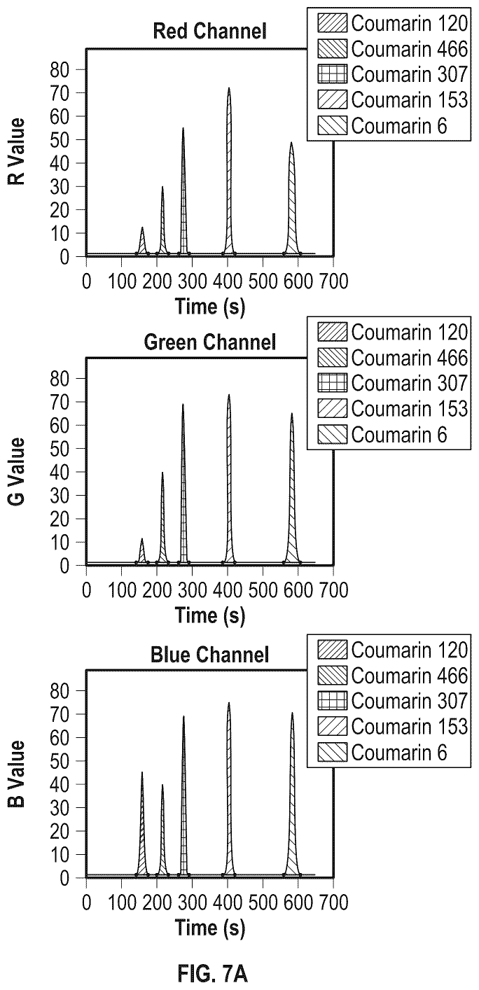

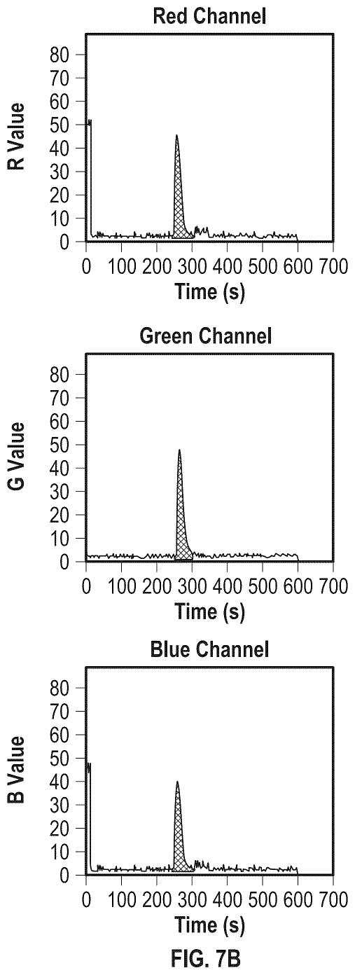

The smartphone was set to record videos using the rear-facing camera when the sample solution was injected into the HPLC All videos were processed using a customized MATLAB script. Upon opening the video in MATLAB, a region of interest (ROI) was selected. MATLAB code provided three chromatograms based on red, green, and blue (RGB) values versus time, as shown in FIG. 7A and FIG. 7B, by averaging the RGB values (of each pixel captured) from the selected ROI for each frame of the video. By manually selecting the peaks, MATLAB code calculated the area, height, width, and retention time of the peaks from the chromatograms. As observed in FIGS. 7A and 7B, the signal intensity for each peak was not equal in the three chromatograms. Since the peak intensity in each chromatogram depends on the maximum emission wavelength of the particular dye molecules, longer wavelengths produced higher intensities for R and G values in the chromatograms. For optimization purposes and for construction of calibration curves, the R value was used to determine the peak area of rhodamine B, the B values were used for peak areas of coumarin 120 and coumarin 466, and the G values were used for peak areas of coumarin 307, coumarin 153, and coumarin 6. A LED with a maximum wavelength of 570 nm was used. A flow cell width and slit diameter of 1.0 mm and 3.0 mm, respectively, were used for these separations.

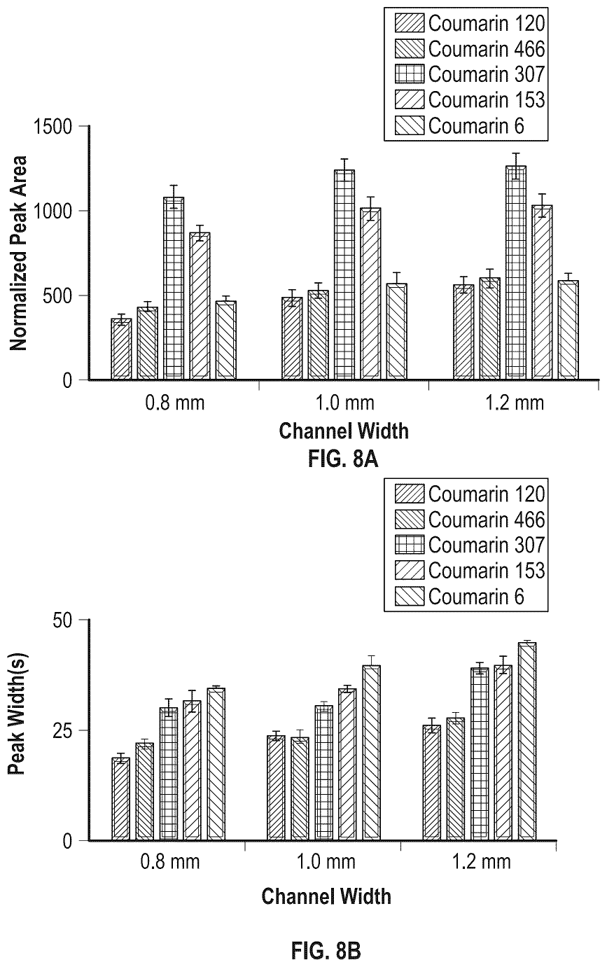

Subsequently, channel dimension widths in the range of 0.8 to 1.2 mm were examined. To carry out these measurements, a mixture of five coumarin dyes at a specific concentration as described above was separated under a constant flow rate and mobile phase composition to eliminate the effect of diffusion coefficient on extra-column band broadening. By increasing the channel width, the linear flow velocity decreased resulting in increased exposure time of the analytes to the excitation source. Therefore, a larger number of molecules within the band were promoted to an excited state resulting in increased fluorescence intensity. As shown in FIG. 8A, peak areas for all analytes increased by 15% to 35% using a channel width of 1.0 mm. However, decreased linear flow velocity resulted in increased diffusion of analytes from regions of high to low concentration producing band broadening and loss of separation efficiency. It is observed in FIG. 8B that increasing the channel width resulted in broader chromatographic peaks. Based on the results, a channel width of 1.0 mm was chosen to reduce extra-column band broadening while achieving acceptable detection sensitivity.

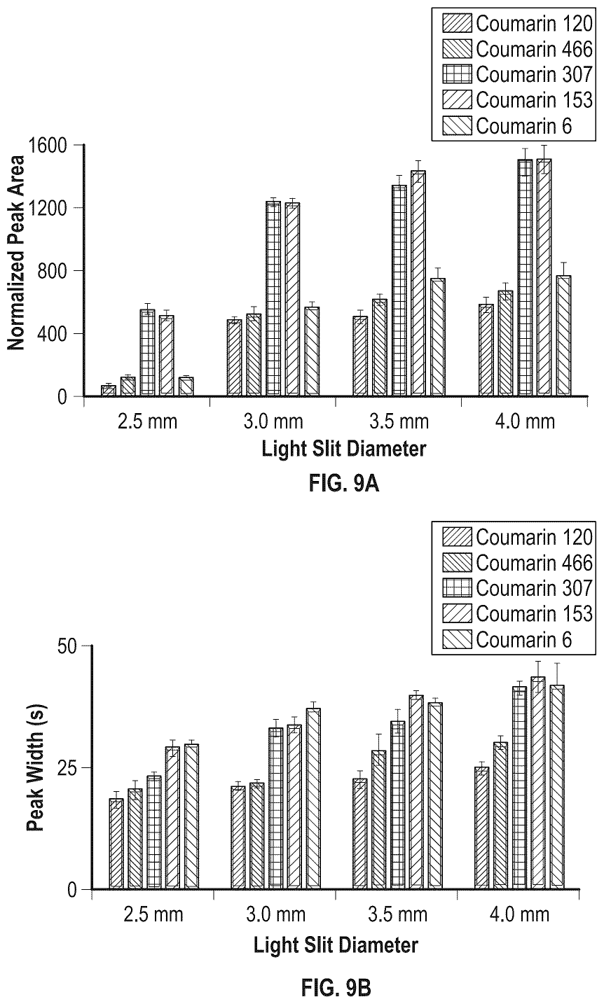

A series of light slit diameters ranging from 2.5 to 4.0 mm were subsequently studied. As seen in FIG. 9A, peak areas increased by 121% to 546% for all dyes using a slit diameter of 3.0 mm, while they increased by only 4% to 32% when a slit diameter larger 3.0 mm was used. This is likely due to more light reaching the flow cell at larger slit diameters causing excitation of more fluorescent molecules; however, a wider pathlength of the flow cell is exposed to the light, resulting in an increased light exposure time of the band and wider chromatographic peaks as shown in FIG. 9B. To maintain high chromatographic efficiency and acceptable sensitivity, a slit diameter of 3.5 mm was chosen.

### Example 2: Double-Channel Flow Cell Permitting the Detection of Two Dye Molecules

A double-channel flow cell comprised of two fiber optic cables and two monochromatic LEDs was used in this Example according to FIG. 5A and FIG. 5B. The detection methods are as outlined in Example 1 and flow cells were fabricated as described in Example 1, but with a second channel and a second fiber optic cable added to the double-channel flow cell to direct emitted light from the second channel to the connector and smartphone. Each fiber optic cable is used for transferring emitted light from the flow cell to the connector box for smartphone imaging.

A disadvantage of monochromatic LEDs is that they provide light featuring a narrow wavelength range of about 60 nm, which allows detection of analytes having small excitation wavelength ranges. To overcome this limitation, monochromatic LEDs providing a desired range of wavelengths in each HPLC run are employed. Applying several monochromatic LEDs requires a flow cell with more than one channel for the detection of dyes requiring more than one wavelength range. In this example, a double-channel flow cell was analyzed. The double-channel design has a continuous pathway that directs eluent through channels equipped with different monochromatic LEDs. Emitted fluorescent from each channel is captured as a video that is simultaneously recorded by the smartphone camera. This increases the selectivity by enabling the use of LEDs that emit light corresponding to the excitation wavelength range of a particular fluorescent molecule.

To test the performance of the double-channel flow cell, four mixtures containing different combinations of coumarin 120 (1.5 mg L-1), coumarin 466 (2.0 mg L-1), coumarin 307 (1.5 mg L-1), coumarin 153 (6.0 mg L-1), coumarin 6 (4.5 mg L-1) and rhodamine B (20.0 mg L-1) were prepared. The first solution was a mixture consisting of coumarin 120, coumarin 466, coumarin 153 and coumarin 6, while the second solution consisted only of rhodamine B. The third solution was a mixture consisting of coumarin 120, coumarin 466, coumarin 153, coumarin 6, and rhodamine B. These three solutions were used to investigate the feasibility of simultaneous fluorescence detection using different excitation wavelengths within the double-channel flow cell design.

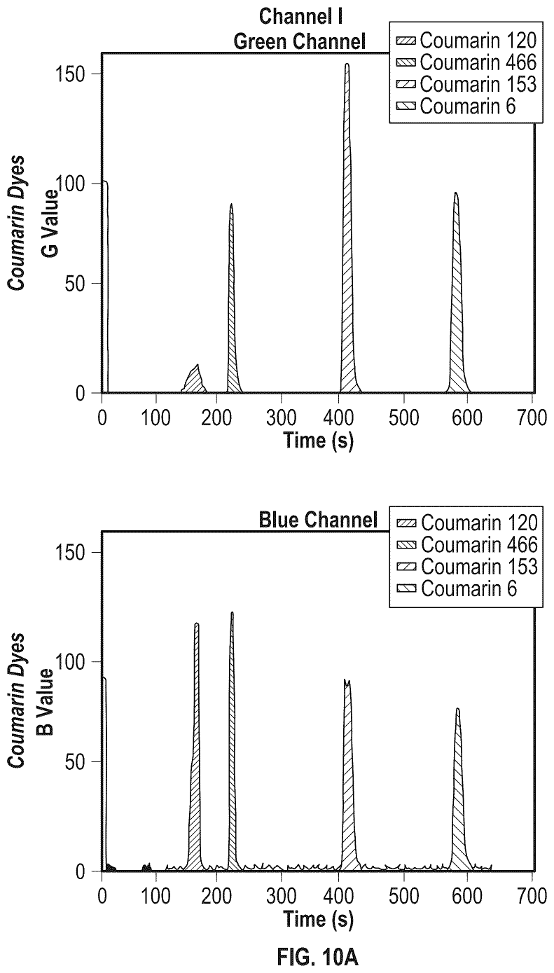

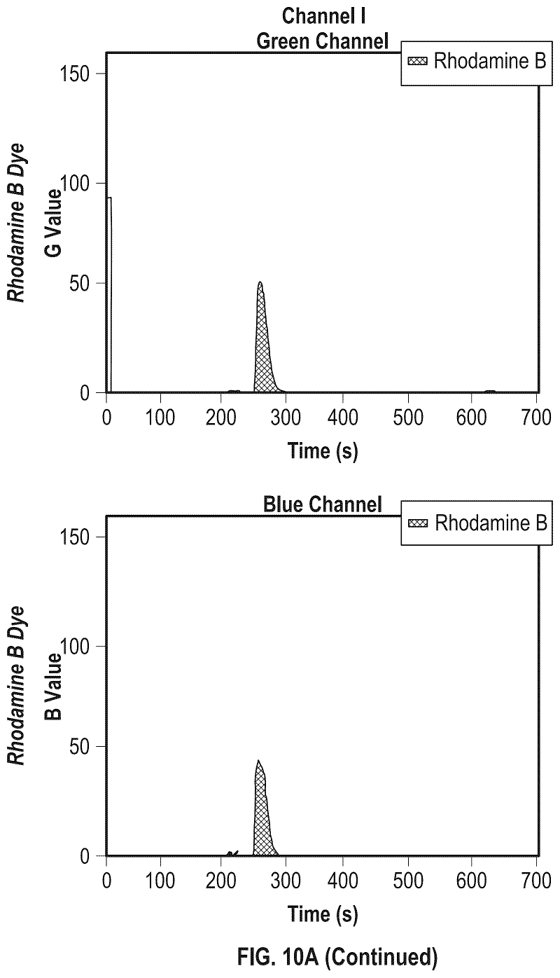

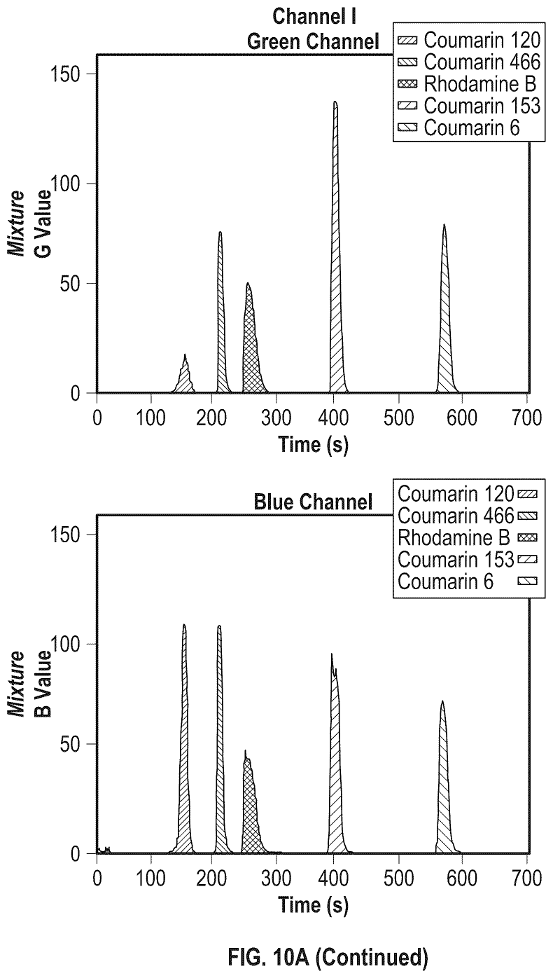

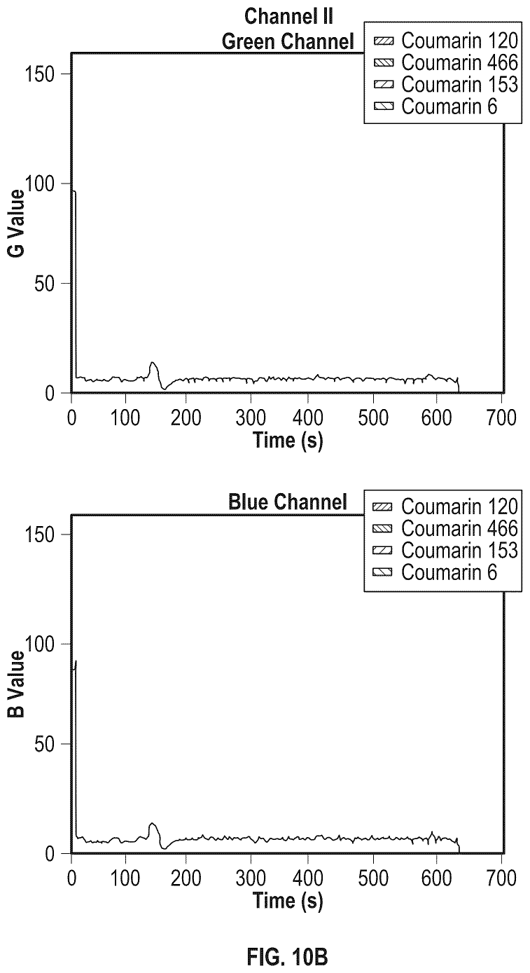

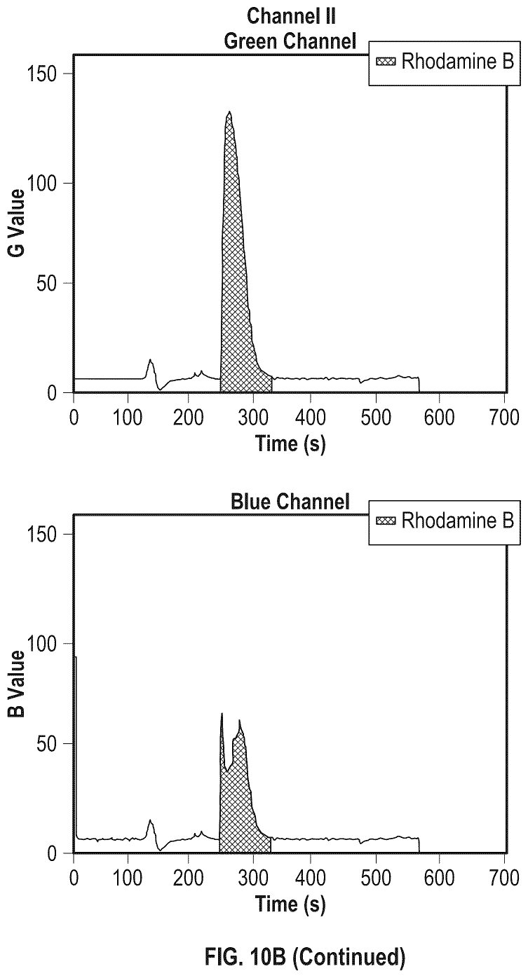

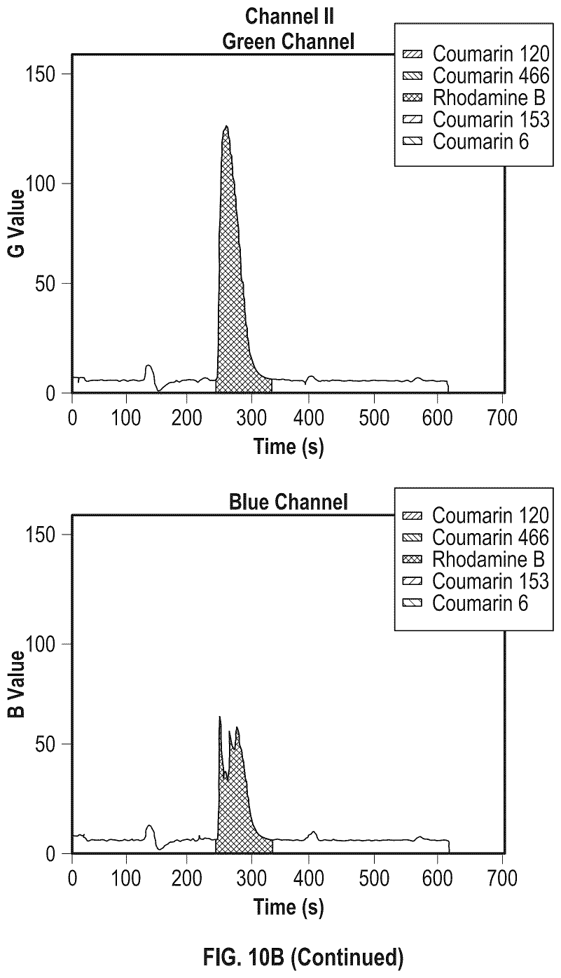

The double-channel flow cell consists of two continuous and connected pathways with the first channel being equipped with a 375 nm LED which lies near the maximum excitation wavelength of coumarin dyes, while the second channel featured a 570 nm LED to detect rhodamine B dye. The three solutions were separated by HPLC and chromatograms for both channels are shown in FIG. 10A and FIG. 10B. Separation of four coumarin dyes from the first solution (FIGS. 10A and 10B, top row) was achieved with fluorescence being detected only in the first channel. This is due to coumarin dyes absorbing within an excitation range of 250-500 nm and emitting fluorescence between 400-600 nm. In the case of rhodamine B, it appeared in chromatograms from both channels (FIGS. 10A and 10B, middle row) since the two LEDs facilitate fluorescence emission. However, the signal from the second channel was of higher intensity than the first due to lower absorption in the first channel. The maximum absorption wavelength of rhodamine B is near 550 nm. As expected, its signal intensity in the second channel was greater than that of the first channel, thereby demonstrating the selectivity of this channel. When the third mixture consisting of four coumarin dyes and rhodamine B was chromatographically separated (FIGS. 10A and 10B, bottom row), five peaks were detected in channel one and one peak (rhodamine B) was detected in channel two.

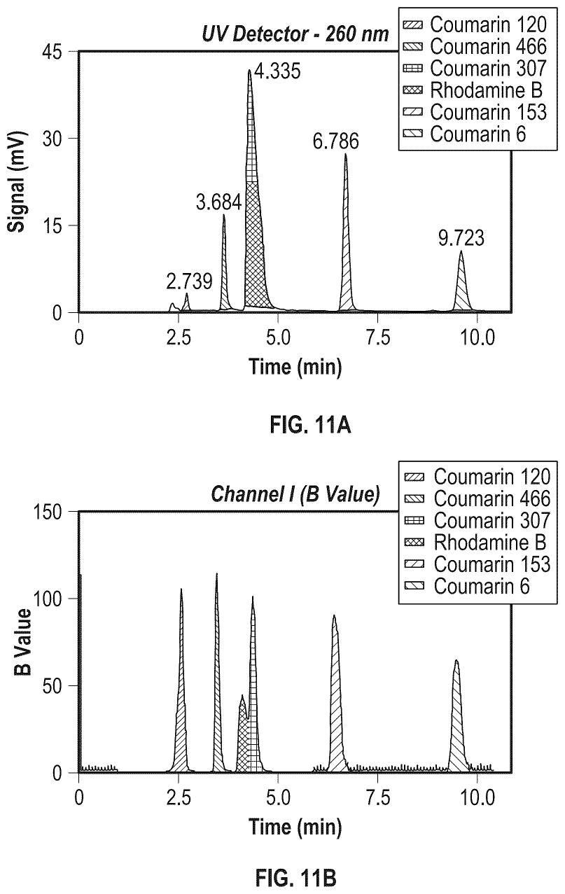

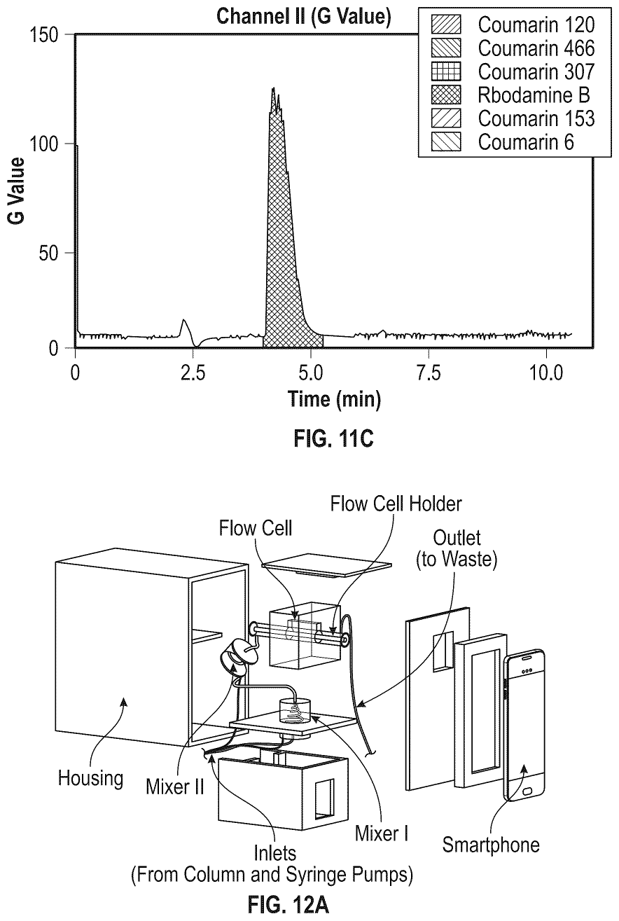

To demonstrate the ability of the double-channel detection strategy to identify and distinguish overlapped peaks in the chromatogram and allow a comparison with a standard UV detector, coumarin 307 was selected and added to the mixture of dyes. Since the retention times of coumarin 307 and rhodamine B are similar, their peaks were overlapped when analyzing the six-component mixture. As shown in FIG. 11A, UV detection was not able to distinguish between coumarin 307 and rhodamine B due to spectral interference. The chromatogram in FIG. 11B for Channel I revealed coumarin 307 and rhodamine B at a retention time of 4.5 min. As expected, the chromatogram from the second channel showed only the rhodamine B peak, permitting its detection without chromatographic interference from coumarin 307 as demonstrated in FIG. 11C.

The proposed device provides a low-cost and portable detection technique for HPLC. It is small and has low-cost and low-maintenance optical parts. Additionally, a wide variety of LEDs with different wavelengths can be utilized to detect a wide range of fluorescent molecules. The detection method has the ability to be extended to a multi-channel design that enables users to employ several LEDs with different wavelengths simultaneously, resulting in higher sensitivity for analyzing various fluorescent compounds. While the output of the detection is three chromatograms drawn based on the RGB channel, the user can choose the channel with higher sensitivity for each analyte depending on a maximum fluorescent wavelength.

### Example 3: Single-Mixer Smartphone-Based Chemiluminescence Detector Coupled to HPLC

For this Example, and the following examples directed to chemiluminescence, the following components were utilized.

The analytes tyramine (≥98%) and carbamazepine (≥98%) were obtained from Sigma-Aldrich (St. Louis, MO, USA). Hordenine (>98%), 1-(4-trifuoromethylphenyl) piperazine (>98%) and 1-(2-chlorophenyl) piperazine (>98%) were purchased from TCI (Montgomeryville, PA). Octopamine hydrochloride (99%) and 1-(3-(trifluoromethyl)phenyl) piperazine (98%) were sourced from Thermo Fisher Scientific (Waltham, MA) and synephrine (98%) was obtained from Indofine (Hillsborough Township, NJ). The reagents potassium permanganate (KMnO₄) (99%), sodium polyphosphate (>99%), sulfuric acid (H₂SO₄), trifluoroacetic acid (99%), methanol (HPLC grade, ≥99%) and 2-propanol (HPLC grade, ≥99%) were obtained from Thermo Fisher Scientific. Cerium (IV) sulfate tetrahydrate (≥98%), tris(2,2′-bipyridyl)dichlororuthenium(II) hexahydrate (Ru(BPY)₃) (≥99%) and chloroform (98%) were purchased from Sigma-Aldrich. Deionized water with a resistivity of 18.2 MΩcm was obtained using a Milli-Q water filtration system (Millipore, Bedford, MA). All analytes were prepared at a concentration of 500 mg/L in methanol and stored at 4° C.

The stock solution of cerium (IV) sulfate (Ce(SO₄)₂) was prepared at a concentration of 0.1 mol/L in 0.5 mol/L H₂SO₄. Standard solution was then prepared prior to use by diluting the stock solution.

An exemplary smartphone-based chemiluminescence detector is shown in FIG. 12A and FIG. 12B. For these Examples, the housing and housing components were fabricated from black polylactic acid (PLA) using an Ultimaker S5 printer, while the flow cell was fabricated from clear resin utilizing a Form Labs printer.

Generally, the rear-facing camera of the smartphone was utilized to detect and record chemiluminescent light. As illustrated in FIG. 12A and FIG. 12B, the smartphone was connected to a rectangular cuboid housing (190×185×110 mm). The housing eliminated interference from surrounding light and accommodated other components and was designed to position the smartphone camera perpendicular to the flow cell where the chemiluminescence reaction occurs and light is emitted. Samsung S20, Samsung S22 and LG G8 ThinO smartphones were employed. Since the arrangement of the camera varies for each smartphone, compatible housing lids were designed and used based on the location of the camera on the smartphone to ensure an appropriate angle to the flow cell.

A single-mixer detector as depicted in FIG. 18 was designed and tested for the chemiluminescence reaction with acidic KMnO₄. KMnO₄ was introduced into mixer (M) at a flow rate of 0.95 mL/min, using a peristaltic pump, and mixed with eluent from the column (C). The mixture was then directed to the flow cell (FC).

A Shimadzu LC-20A HPLC system (Tokyo, Japan), featuring a 20 μL Rheodyne manual injector, was used in the study. For detector optimization and the construction of carbamazepine calibration curves, separations were performed using a Restek Ultra C18 analytical column (250 mm×4.6 mm i.d., 5 μm particle size) obtained from Restek Corporation (Bellefonte, PA, USA). To demonstrate the detector's versatility in detecting chemiluminescence from the reaction of Ru(BPY)3 and KMnO4 with various analytes (i.e., the piperazine compounds and the phenolic phenethylamines), an Ultra Amino analytical column (250 mm×4.6 mm i.d., 5 μm particle size) from Restek Corporation was employed. In all experiments, separations were conducted at room temperature using isocratic mode with a methanol:water (70:30, v/v) mobile phase at a constant flow rate of 1 mL/min.

Acidic KMnO₄ reagent was composed of 0.5 mmol/L KMnO₄ and 0.5 (w/v) sodium polyphosphate in a 5.0 mmol/L H₂SO₄ solution. The reagent was then directed to the mixer at a flow rate of 0.95 mL/min. The mixer was connected to a cylindrical flow cell with a length of 4.0 cm and an inner diameter of 4.0 mm.

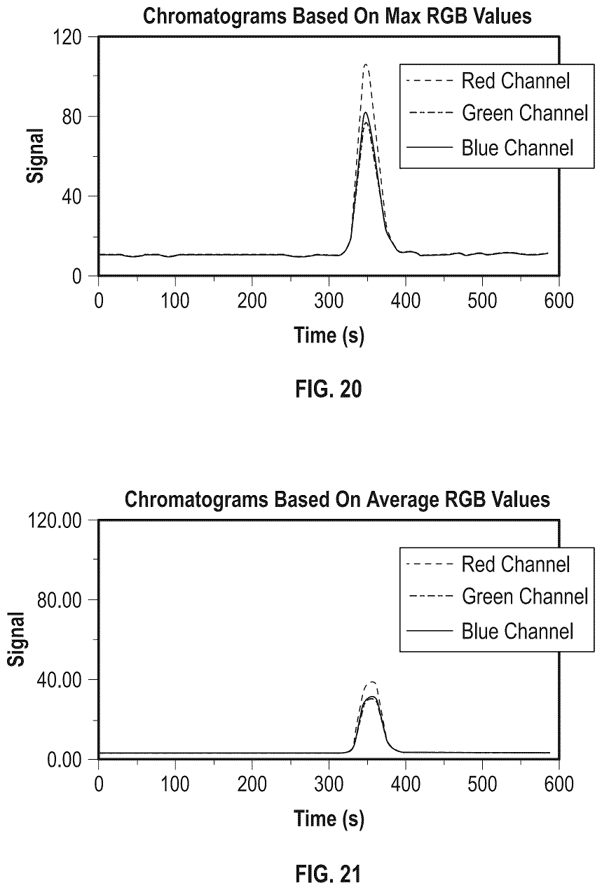

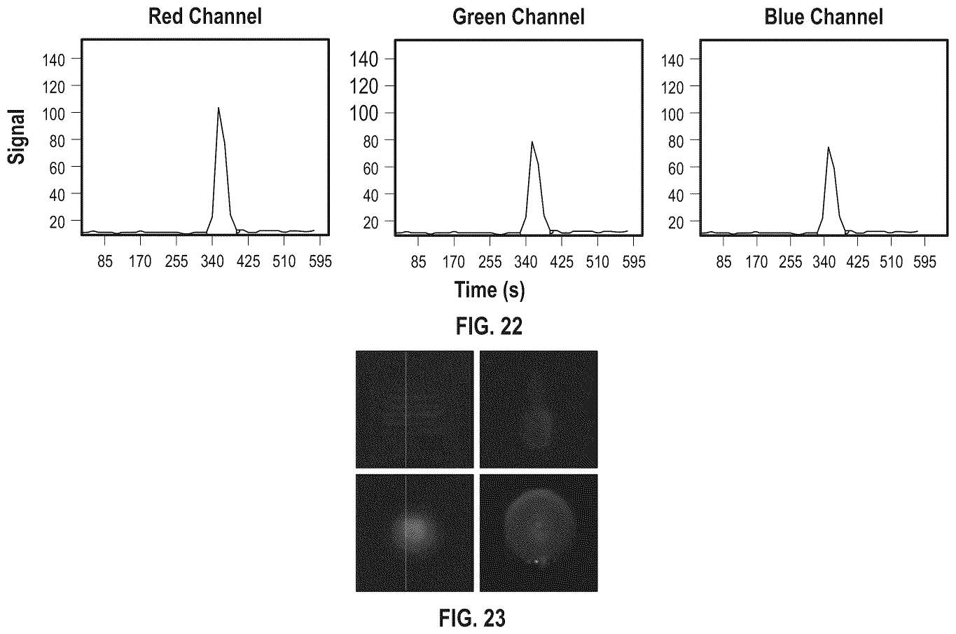

Light emitted by chemiluminescence was recorded through images captured from the flow cell's window during each HPLC run. To record the emitted chemiluminescent light, images were sequentially taken with a constant shutter speed of the smartphone camera. Using a commercial application (GC Auto Click), acquisition of an image was initiated 800 ms after completion of the previous image capture. This process began from the moment of analyte injection and continued until the end of the chromatographic separation. The images were then uploaded into a MATLAB script. Within MATLAB, a ROI was selected for analysis across all images. MATLAB measured both the maximum and average red, green and blue (RGB) values of each pixel within the ROI. The code then generated three chromatograms based on the time versus RGB values, utilizing both average and maximum RGB values. Chromatograms based on maximum RGB and average RGB values for the carbamazepine standard analyzed using HPLC equipped with a smartphone-based chemiluminescence detector are presented in FIG. 20 and FIG. 21. The height, area, width, and retention time from the chromatograms is shown in FIG. 22. As shown in FIG. 20 and FIG. 21 the signal intensity from the chromatograms based on maximum RGB values is higher than that based on average RGB values. Moreover, the signal intensity for the carbamazepine peak is different in the red, green and blue channels. This variation is due to the longer emission wavelength of the chemiluminescent signal resulting in higher intensities for red and green values in the chromatograms. For optimization purposes and construction of calibration curves, the red channel value from the maximum RGB-based chromatogram was employed for determination of peak height.

### Example 4—Evaluating Flow Cell Designs

Four flow cell designs featuring different fabrications methods were developed and tested. The flow cell designs are shown in FIG. 13. FIG. 13 shows schematic illustrations for a linear channel flow cell (Model 1), a rectangular chamber flow cell (Model 2), a cylindrical chamber flow cell (Model 3), and a spiral channel flow cell (Model 4). Model 4 incorporates a built-in mixer, with tubing connected directly to the flow cell.

Model 1 and Model 2 flow cells were fabricated using 1.5 mm thick PMMA sheets. The channel networks were developed on the PMMA sheet using a laser cutter. This layer was sandwiched between two other layers and the three layers bound together and sealed with chloroform. The inlet and outlet holes were drilled into one of the outer layers. Model 3 was 3D printed and features a window prepared from transparent PMMA. Model 4 was 3D printed using a Form3 stereolithography printer with clear resin. After fabrication of the flow cells, all surfaces of the cell, except for the window, were covered with aluminum foil to further isolate the flow cell from surrounding light and to improve capture of chemiluminescence light by reflecting light towards the detector. Suitable holders were then designed and 3D printed for each flow cell and the flow cells were positioned at a constant distance (2.7 cm) from the smartphone camera, as shown in FIG. 14. Except for Model 4, which incorporated a built-in mixer in its design, all flow cells were connected to an external mixer to ensure thorough mixing of reagents before entering the flow cells.

A standard of carbamazepine (50 mg/L) was subjected to separation by HPLC. Eluent from the column was then mixed with appropriate reagents through mixers and directed to the flow cells for emission of chemiluminescent light and smartphone detection. FIG. 23 provides a comparative analysis of the four different flow cells tested, with each image capturing the maximum value of the signal intensity to illustrate the variation in signal intensity across the designs. In FIG. 23, the image in the top left is for the fuel cell Model 1 as shown in FIG. 13, the image in the top right is for Model 2, the image in the bottom left is for Model 3, and the image in the bottom right is for Model 4.

Chemiluminescence detection was demonstrated with various flow cell designs. In this Example, Model 3 exhibited enhanced compatibility with smartphone detection, as can be observed from its high light intensity. This result can be attributed to its smaller detection window, which enhances chemiluminescent light by providing a more defined ROI for the smartphone detector. Additionally, the use of transparent PMMA as the detection window in this design permits more efficient transmission of chemiluminescent light to the smartphone camera compared to the 3D printed clear resin, thereby reducing signal loss as light passes through the window to reach the detector.

### Example 5—Evaluating Mixer Design

In the post-column chemiluminescence reaction, achieving a stable baseline and reproducible signal is important. This can be accomplished by ensuring that the eluent from the HPLC column is thoroughly and rapidly mixed with the reagent solutions. Additionally, the time needed to reach maximum intensity is influenced by the physical processes of solution mixing and reaction kinetics. To achieve maximum signal intensity and optimal reproducibility, it is also important to optimize the mixer design.

The mixers were 3D printed from clear resin using a Form3 3D printer. The arrangement and number of mixers within the chemiluminescent detection system depends on the chemiluminescent reaction between the analyte and the reagent. In this Example, two detection systems consisting of single-mixer and double-mixer setups were fabricated. A schematic of the single mixer is shown in FIG. 18 and a schematic of the double mixer is shown in FIG. 19. Prior to the chemiluminescence reaction, the reagents were directed to the mixers using syringe pump and peristaltic pump at a flow rate of 0.95 mL/min and mixed with the mobile phase. PTFE tubing (0.7 mm inner diameter and 1.6 mm outer diameter) was used to transfer reagents to the mixer and facilitate a connection between the mixer and the flow cell. PEEK tubing (0.25 mm inner diameter and 1.6 mm outer diameter) was used for transferring the mobile phase from the HPLC to the mixer.

A constant spiral design with an inner diameter of 1.25 mm was selected for mixer I as shown in FIG. 15, while different designs were explored for mixer II. To investigate the effects of the mixer, Y-shaped mixers as shown in FIG. 17 and spiral mixers as shown in FIG. 16 with different inner diameters were designed and tested.

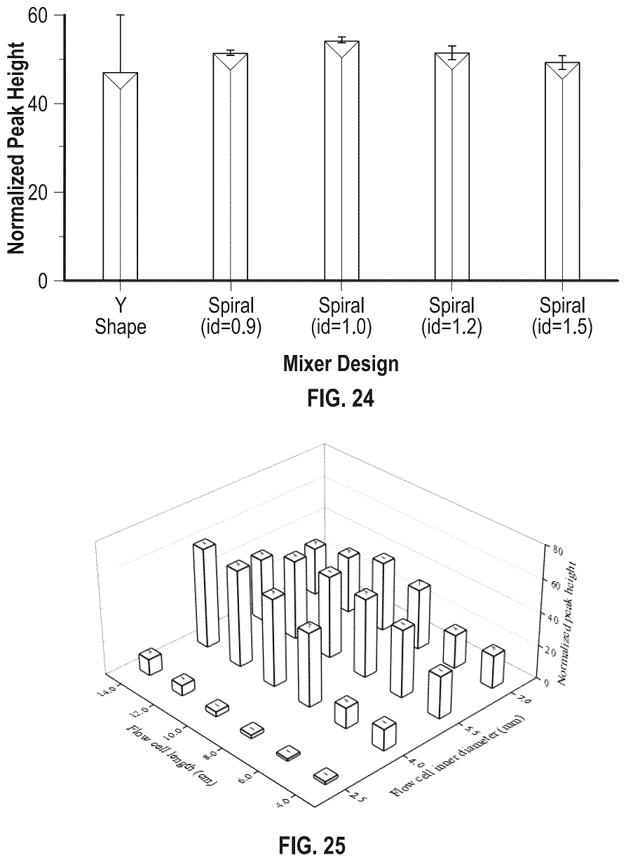

The mixers were connected to a cylindrical flow cell featuring a length of 7.0 cm and an inner diameter of 5.5 mm. A carbamazepine standard (20 mg/L) was then subjected to HPLC separation and analyzed. As shown in FIG. 24, the Y-shaped mixer exhibited poorer reproducibility. Construction of the spiral mixer was limited by the 3D printer, as designs with an inner diameter smaller than 0.9 mm yielded low printing success. Mixers with an inner diameter ranging from 0.9 to 1.5 mm were studied, with the mixer featuring an inner diameter of 1.0 mm providing higher signal intensity and reproducibility. Consequently, a spiral mixer with an inner diameter of 1.0 mm was selected as the preferred mixer.

### Example 6—Evaluation of Flow Cell Inner Diameter and Length

The flow cell's inner diameter and length are dependent variables that influence its volume, and the overall sensitivity of the chemiluminescence detector. To investigate optimized flow cell dimensions for a cylindrical flow cell, the inner diameter and length of the flow cell were simultaneously studied and optimized. The tests were performed by injecting the carbamazepine standard and detecting the band using flow cells featuring an inner diameter ranging from 2.5 to 7.0 mm, while the length of the flow cell was varied from 4.0 to 14.0 cm. All flow rates were fixed with the total flow to the flow cell being adjusted to 2.9 ml/min in all tests. All measurements were performed in triplicate.

By increasing the flow cell length, the volume could be increased resulting in a larger volume of the reagent-analyte mixture being exposed to the detector window. Given that the reagent and analyte undergo a chemiluminescent reaction, prolonged exposure to the window was found to enhance the amount of emitted light that reaches the detector, leading to increased sensitivity. However, increasing the length of the flow cell results in the camera being farther from the center of the flow cell, which leads to a decreased signal due to loss of light prior to reaching the detector. Additionally, it was observed that increasing the length of the flow cell beyond 12 cm also increased the possibility of a printing failure due to bending in the printed model.

Reducing the flow cell's diameter was found to decrease the ROI and result in more focused chemiluminescent light and higher sensitivity. However, smaller diameters also reduce the flow cell's volume and increase the flow velocity within the flow cell, resulting in less time for the reagent and analyte mixture to emit light inside the flow cell, potentially causing a decrease in sensitivity. FIG. 25 shows a graph of peak height (x-axis) by length of low cell (y-axis) and inner diameter of the flow cell (z-axis). As shown in FIG. 25, the maximum peak height was obtained using flow cells with an inner diameter of 4.0 mm and lengths exceeding 10 cm. Considering the balance between sensitivity and practicality of printing, a flow cell with a length of 12 cm and an inner diameter of 4.0 mm was preferred.

### Example 7: Double-Mixer Smartphone-Based Chemiluminescence Detector Coupled to HPLC

An exemplary double-mixer smartphone-based chemiluminescence detector is shown in FIG. 12A and FIG. 12B. A schematic diagram of the smartphone-based chemiluminescence detector for HPLC is presented in FIG. 19. The system incorporates dual mixers (M1 and M2) for sequential mixing of reagents.

Ru(BPY)₃ was introduced into M1 at a flow rate of 0.95 mL/min using a peristaltic pump (P) and was mixed with eluent from column (C). The mixture then was directed to M2 where it was combined with Ce(SO₄)₂, delivered by the syringe pump at a flow rate of 0.95 mL/min. The final mixture was directed to the flow cell (FC). This system was also used to successfully detect 1-(4-trifluoromethylphenyl)piperazine, 1-(2-chlorophenyl) piperazine, and 1-(3-trifluoromethylphenyl)piperazine.

### Example 8—Evaluation of Reagent Concentration

To assess the capabilities of the detector and achieve optimization of the system, the chemiluminescence reaction involving carbamazepine, Ce(SO₄)₂, and Ru(BPY)₃ was utilized in a system with two mixers as described in the previous Example. In this example, the effects of varied acid concentration and employed reagents were investigated. The acidity of the Ce(IV) solution was adjusted using different concentrations of H₂SO₄ ranging from 10 mmol/L to 150 mmol/L to examine its effects on the chemiluminescence signal. Tests were performed using 0.2 mmol/L of Ru(BPY)₃ and 0.6 mmol/L of Ce(SO₄)₂, with both reagents entering the mixers using flow rates of 0.95 mL/min.

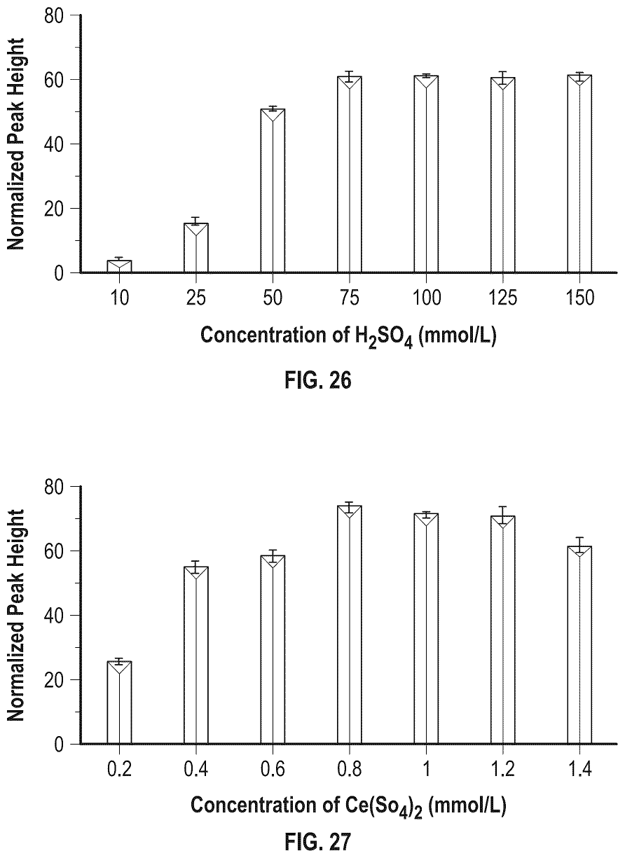

The results revealed that the intensity of chemiluminescent light increased with an increase in acid concentration to 75 mmol/L, beyond which a plateau was observed, as shown in FIG. 26.

To evaluate the concentration of Ce(SO₄)₂ on chemiluminescence intensity, a range of concentrations from 0.2 to 1.4 mmol/L were explored. The tests were conducted using 0.2 mmol/L of Ru(BPY)₃ and 75 mmol/L of sulfuric acid, with the reagents entering the mixers at a flow rate of 0.95 mL/min. It was observed that the chemiluminescence signal was enhanced with an increased concentration of Ce(SO₄)₂ up to 0.8 mmol/L and then decreased at higher concentrations, as illustrated in FIG. 27.

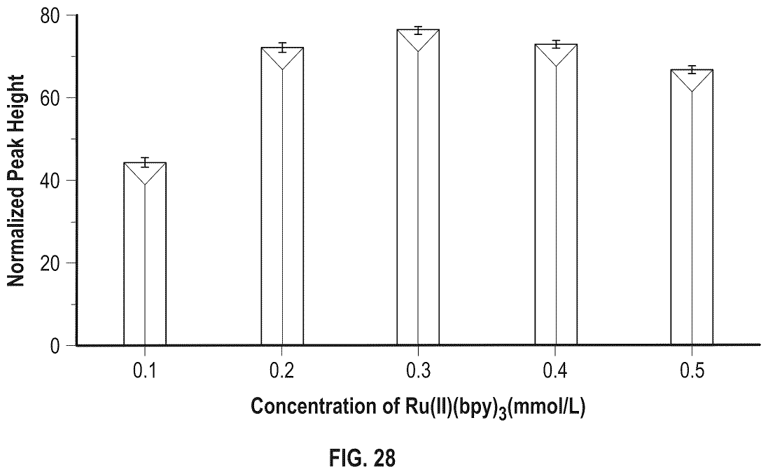

Similarly, to evaluate the concentration of Ru(BPY)₃ on the chemiluminescence intensity, a range of concentrations from 0.1 to 0.5 mmol/L were explored. The tests were conducted using 75 mmol/L of sulfuric acid and 0.8 mmol/L of Ce(SO₄)₂, with the reagents entering the mixers at a flow rate of 0.95 mL/min. The chemiluminescence signal was found to be enhanced with an increased concentration of Ru(BPY)₃ up to 0.3 mmol/L beyond which a decrease was observed, as represented in FIG. 28.

Chemiluminescence detection was demonstrated over varied concentrations of reagents and acidity.

### Example 9—Evaluating Smartphone Parameters

The smartphone's camera settings, particularly the integration time (the duration of time that the camera sensor collects light) was observed to have a direct impact on signal intensity and were investigated using the Samsung S20 system. This smartphone offers a range of integration times for video recording ( 1/12000 to 1/30 s) and images capture ( 1/12000 to 30 s). Initially, the feasibility of employing video recording for data acquisition was explored. Experiments were conducted using various integration times while subjecting 20 mg/L of carbamazepine to chromatographic separation. The signal-to-noise ratios were found to be below the limit of detection (LOD), leading to sequential image capturing being used instead of video recording to achieve higher integration times.

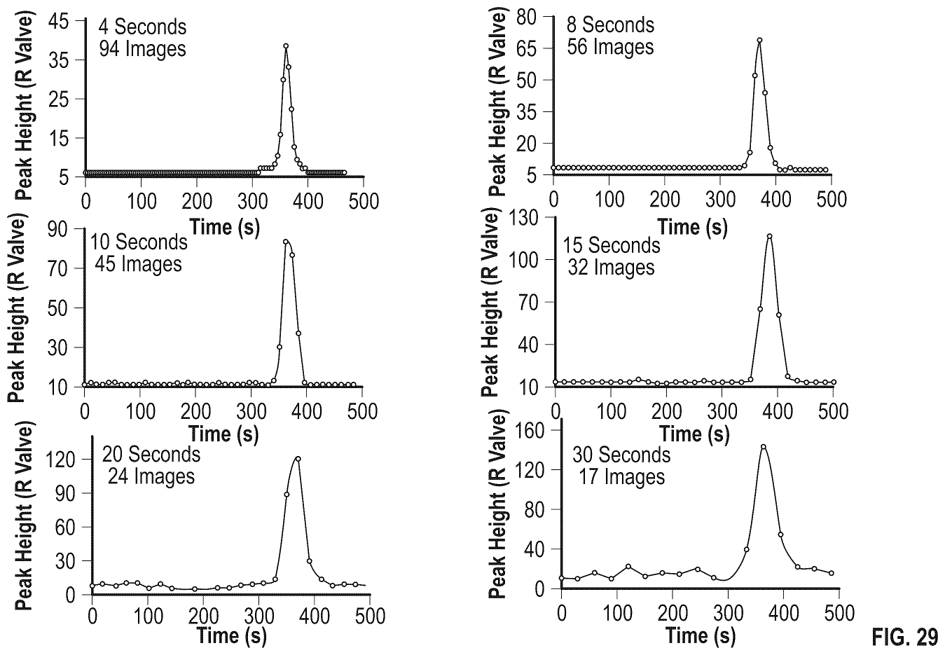

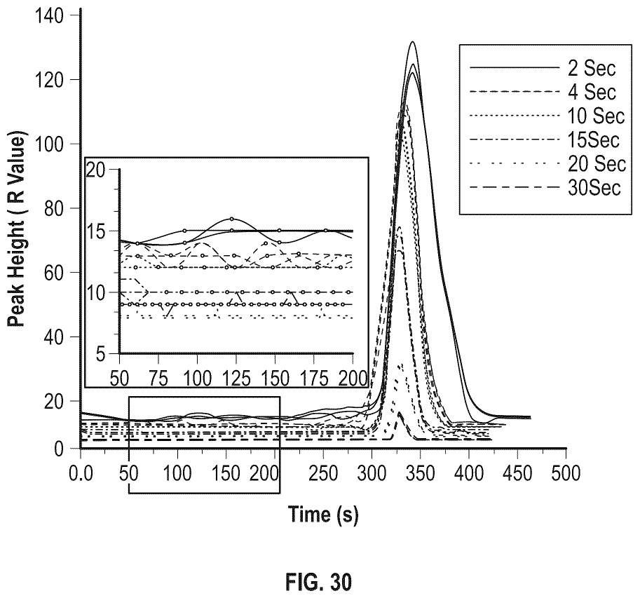

FIG. 29 shows chromatograms plotted using MATLAB after image processing with varying integration times using the sequential image capturing technique. Increasing the integration time from 2 s to 30 s resulted in higher signal intensities, as the camera was able to capture more light. However, this also led to a reduction in the number of images that can be recorded during each HPLC run, consequently reducing the number of data points in the chromatogram which may adversely affect the chromatographic peak shapes and result in increased extra column broadening. Additionally, longer integration times were associated with increased noise within the chromatograms, as shown in FIG. 30. FIG. 29 and FIG. 30 illustrate the impact of shutter speed on chromatographic peak intensity, shape, broadening, and noise level.

### Example 10—Comparing Various Smartphones

The feasibility of employing different brands of smartphones as detectors was explored. Four-point calibration curves were constructed individually using Samsung S20, Samsung S22, and LG G8 ThinQ smartphones. A standard solution of carbamazepine (20 mg/L) was prepared and the concentration of carbamazepine was quantified utilizing each smartphone. To assess significant differences in the data obtained using different smartphones, the collected data were analyzed using a one-way analysis of variance (ANOVA). Based on the critical F value at a significance level of 0.05 (5.14 at α=0.05) and the calculated F value at a significance level of 0.05 (2.43 at α=0.05), it was concluded that no significant variance existed in the results obtained from the various smartphones.

### Example 11—Analytical Parameters and Precision of the Detection Method

The figures of merit of the detector, including linear dynamic range (LDR), limit of detection LOD, and limit of quantification (LOQ), were investigated for the determination of carbamazepine by subjecting different concentrations of carbamazepine standards to HPLC and subsequent detection with Samsung S20 and Samsung S22 smartphones as chemiluminescence detectors, as shown in Table 1.

TABLE 1

| | | | | Determination | | | |
|---|---|---|---|---|---|---|---|
| | LOD | LOQ | LDR | Coefficient | | | |
| Detector | (mg/L) | (mg/L) | (mg/L) | (r²) | Slope ± SD | Intercept ± SD | F_{LOF} |
| Samsung | 1.0 | 3 | 3-30 | 0.997 | 5.15 ± 0.62 | −8.24 ± 0.76 | 0.72 |
| S20 | | | | | | | |
| Samsung | 0.7 | 2 | 2-25 | 0.997 | 8.25 ± 0.45 | 22.04 ± 0.93 | 0.3 |
| S22 | | | | | | | |

The LDR, coefficient of determination, slopes of calibration curves, errors of the intercept, and F_{LoF} were measured using five standard solutions of the analyte at various concentrations levels, the analyses were conducted with both smartphones, and the results are provided in Table 1. The LODs and LOQs for each smartphone were measured by decreasing the analyte concentration until the signal reached a minimum of 3 and 10 times, the average noise level of the detector, respectively. The LOD and LOQ values were determined to be 1.0 mg/L and 3.0 mg/L, respectively, using the Samsung S20 device, while the Samsung S22 device produced lower LOD and LOQ values of 0.70 mg/L and 2.0 mg/L, respectively. Additionally, the LDR for the Samsung S20 device was found to range from 3.0 to 30.0 mg/L with a coefficient of determination of 0.997, whereas for the Samsung S22 device, the LDR ranged from 2.0 to 25.0 mg/L with a coefficient of determination of 0.997.

The sensitivity of the smartphone-based detector described herein demonstrates that it is highly suitable and desirable for various applications. For example, in pharmaceutical monitoring given that the therapeutic range of carbamazepine in plasma is between 4 and 12 mg/L matching that of the LDR for the smartphone-based detector.

### Example 12—Reproducibility and Precision Tests

Intraday and interday precision were evaluated. Three different concentration levels covering low, medium, and high ranges of the LDR were selected. Standard solutions were then prepared and analyzed using the Samsung S20 device as the detector. To measure intraday precision, triplicate injections of standard solutions at various concentration levels were analyzed on the same day (n=3). Interday precision was assessed from injections of standard solutions obtained over a 3 day validation period (n=9). For the intraday and interday precision studies, the relative standard deviation (RSD) values were determined. Intraday precision RSD values ranged from 1.7% to 6.2% (n=3), while the interday precision RSD values ranged from 3.2% to 4.8% (n=9), as shown in Tables 2-4.

TABLE 2
Concentration level I

| | | | Interday | |
|---|---|---|---|---|
| Intraday Precision RSD (%) | | | Precision | |
| Day 1 | Day 2 | Day 3 | RSD (%) | F(2, 6) |
| 6.2 | 6.0 | 2.5 | 4.8 | 0.6 |

TABLE 3
Concentration Level II

| | | | Interday | |
|---|---|---|---|---|
| Intraday Precision RSD (%) | | | Precision | |
| Day 1 | Day 2 | Day 3 | RSD (%) | F(2, 6) |
| 1.7 | 4.3 | 4.1 | 3.2 | 1.9 |

TABLE 4
Concentration Level III

| | | | Interday | |
|---|---|---|---|---|
| Intraday Precision RSD (%) | | | Precision | |
| Day 1 | Day 2 | Day 3 | RSD (%) | F(2, 6) |
| 2.5 | 4.5 | 1.8 | 3.7 | 2.51 |

To assess whether significant differences exist among the data collected on three separate days, a one-way ANOVA was performed, and F-values were calculated at a significance level of 0.05. Based on the calculated and critical (5.14 at α=0.05) F-values at a significance level of 0.05, it was concluded that no significant variance in the results was obtained over the three days.

### Example 13—Versatility of Smartphone-Based Detector in Detecting Various Analytes

To demonstrate the detector's versatility in detecting chemiluminescence from the reaction of Ru(BPY)₃ with various analytes, chemiluminescence emitted from 1-(4-trifluoromethylphenyl)piperazine, 1-(2-chlorophenyl)piperazine, and 1-(3-trifluoromethylphenyl)piperazine was observed.

To evaluate the applicability of the detector with other chemiluminescence reagents, acidic KMnO₄ was selected as one of the most popular chemiluminescence reagents and its chemiluminescence reaction with tyramine, hordenine, octopamine, and synephrine was studied. The chemiluminescence emission of the analytes was detected following their reaction with acidic KMnO₄. Standards of the analytes (20 mg/L) were subjected to HPLC separation followed by detection of the bands using a smartphone-based device. Peak heights for the different analytes were measured based on RGB values, as reported in Table 5 and the results confirmed the detector's capability to detect additional analytes and its adaptability with different reagents.

TABLE 5

| | | Peak Height | | | RSD (%) | | |
|---|---|---|---|---|---|---|---|
| Analyte | Reagent | R | G | B | R | G | B |
| Carbamazepine | Ru(BPY)₃ | 118 | 95 | 89 | 2 | 1.6 | 2.2 |
| 1-(4- | Ru(BPY)₃ | 150 | 123 | 112 | 4.1 | 4.9 | 7.2 |
| Trifluoromethylphenyl) | | | | | | | |
| piperazine | | | | | | | |
| 1-(2- | Ru(BPY)₃ | 149 | 122 | 110 | 4.4 | 5.4 | 3.5 |
| Chlorophenyl)piperazine | | | | | | | |
| 1-(3- | Ru(BPY)₃ | 126 | 100 | 95 | 1.8 | 2.9 | 2.7 |
| Trifluoromethyl- | | | | | | | |
| phenyl)piperazine | | | | | | | |
| Tyramine | KMnO₄ | 38 | 34 | 33 | 6.0 | 3.4 | 5.2 |
| Hordenine | KMnO₄ | 40 | 35 | 34 | 6.6 | 2.9 | 4.4 |
| Octopamine | KMnO₄ | 24 | 23 | 24 | 2.4 | 4.3 | 4.2 |
| Synephrine | KMnO₄ | 32 | 28 | 29 | 3.1 | 3.6 | 5.3 |

Optimization of reagent conditions and detector parameters, such as the size of the flow cell and mixers, is required prior to the analysis of each group of analytes in order to enhance sensitivity due the unique reaction kinetics of each chemiluminescence reaction. The ability to use 3D printing technology in the design and fabrication of the detector enhances customization and facilitates the creation of optimized configurations tailored to specific chemiluminescence reactions.

The inventions being thus described, it will be obvious that the same may be varied in many ways. Such variations are not to be regarded as a departure from the spirit and scope of the inventions and all such modifications are intended to be included within the scope of the following claims.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is further defined by the following numbered embodiments.

Embodiment 1: A flow cell comprising at least one channel with an inlet and an outlet configured for a mobile phase to enter the channel through the inlet and exit the channel through the outlet; at least one LED light source; and a fiber optic cable, wherein the channel is exposed to the LED light source through a slit, and wherein the fiber optic cable is positioned to capture emitted light from the mobile phase as it passes by the LED light source.

2. The flow cell according to embodiment 1, wherein the flow cell comprises more than one channel.

3. The flow cell according to embodiment 2, wherein the flow cell comprises more than one LED light source.

4. The flow cell according to embodiment 3, wherein each channel is exposed to a separate LED light source.

5. The flow cell according to any one of embodiments 2-4, wherein the flow cell comprises more than one fiber optic cable and each fiber optic cable is positioned to capture emitted fluorescence from a separate channel.

6. The flow cell according to any one of embodiments 1-5, wherein the channel has a width of about 0.5 mm to about 5 mm, or from about 0.5 mm to about 2 mm, or of about 1 mm.

7. The flow cell according to any one of embodiments 1-6, wherein the slit has a diameter of from about 1 mm to about 10 mm, or from about 2 mm to about 5 mm, or of about 3 mm.

8. The flow cell according to any one of embodiments 1-7, wherein the flow cell has a rectangular top-down shape with a length and/or a width of from about 20 mm to about 100 mm, or from about 30 mm to about 60 mm.

9. The flow cell according to any one of embodiments 1-8, further comprising a housing, wherein the housing surrounds the fuel cell preventing light from entering the fiber optic cable and flow cell.

10. The flow cell according to any one of embodiments 1-9, wherein the channels are comprised of polymethyl methacrylate (PMMA).

11. A fluorescence detection system comprising the fuel cell of any one of embodiments 1-10 and a portable detector configured to capture a signal from the fiber optic cable.

12. The fluorescence detection system according to embodiment 11, wherein the portable detector comprises a smartphone.

13. The fluorescence detection system according to embodiment 11 or 12, further comprising a connector box, wherein the fiber optic cable connects to the connector box and the connector box isolates the portable detector from surrounding light.

14. The fluorescence detection system according to embodiment 13, wherein the connector box fixes the distance and angle of the camera with respect to the end of the fiber optic cable.

15. The fluorescence detection system according to any one of embodiments 11-14 wherein the mobile phase is the output of an HPLC column.

16. A method of fluorescence detection comprising: flowing the mobile phase through the at least one channel of the flow cell according to the fluorescence detection system of any one of embodiments 11-15; capturing the emitted light with the portable detector.

17. The method according to embodiment 16, further comprising providing chromatograms of color intensities of emitted fluorescence versus time.

18. The method according to embodiment 17 wherein the chromatograms comprise red-blue-green (RGB) chromatograms.

19. The method according to any one of embodiments 17 or 18, wherein separate chromatograms are provided for each channel in the flow cell.

20. A fluorescence detection kit comprising: the flow cell according to any one of embodiments 1-10; and a connector box.

21: A chemiluminescence detection system comprising a flow cell configured for a mobile phase and at least one reagent to enter the flow cell through an inlet and exit the flow cell through an outlet.

22. The chemiluminescence detection system according to embodiment 21, wherein the flow cell is a channel flow cell.

23. The chemiluminescence detection system according to embodiment 22, wherein the channel flow cell comprises a linear or spiral channel.

24. The chemiluminescence detection system according to any one of embodiments 22 or 23, wherein the channel flow cell comprises a spiral channel.

25. The chemiluminescence detection system according to embodiment 21, wherein the flow cell is a chamber flow cell.

26. The chemiluminescence detection system according to embodiment 26, wherein the chamber flow cell comprises a rectangular or cylindrical chamber.

27. The chemiluminescence detection system according to any one of embodiments 25 or 26, wherein the chamber flow cell comprises a cylindrical chamber.

28. The chemiluminescence detection system according to embodiment 27, wherein the cylindrical chamber has an inner diameter of from about 2.5 mm to about 7.0 mm, or from about 2.5 mm to about 5.5 mm, or about 4.0 mm.

29. The chemiluminescence detection system according to any one of embodiments 27 or 28, wherein the cylindrical chamber has a length of from about 2 cm to about 20 cm, or from about 4 cm to about 14 cm, or greater than about 10 cm, or about 12 cm.

30. The chemiluminescence detection system according to any one of embodiments 21-29, wherein the flow cell comprises a mixer configured to combine the mobile phase and at least one reagent.

31. The chemiluminescence detection system according to any one of embodiments 21-31, further comprising a flow cell holder configured to hold the flow cell stationary.

32. The chemiluminescence detection system according to any one of embodiments 21-31, further comprising at least one mixer in fluid connection with the flow cell, wherein the mixer is configured to combine the mobile phase and at least one reagent prior to the inlet of the flow cell.

33. The chemiluminescence detection system according to embodiment 32, wherein the mixer comprises a spiral channel.

34. The chemiluminescence detection system according to any one of embodiments 32 or 33, wherein the chemiluminescence detection system comprises two mixers.

35. The chemiluminescence detection system according embodiments 34, wherein the two mixer are configured in parallel and each mixer introduces a separate reagent.

36. The chemiluminescence detection system according to any one of embodiments 21-35, further comprising a housing unit configured to enclose the chemiluminescence detection system of any one of embodiments 21-35.

37. The chemiluminescence detection system according to embodiment 36, wherein the housing unit is configured to hold a portable detector stationary.

38. The chemiluminescence detection system according to any one of embodiments 36-36, wherein the housing unit is comprised of a material that is impenetrable to light.

39. The chemiluminescence detection system according to any one of embodiments 21-38, further comprising a portable detector configured to capture chemiluminescence.

40. The chemiluminescence detection system according embodiment 40, wherein the portable detector comprises a smartphone.

41. The chemiluminescence detection system according to any one of embodiments 21-40, wherein the flow cell is comprised of polymethyl methacrylate (PMMA).

42. The chemiluminescence detection system according to any one of embodiments 21-41 wherein the mobile phase is the output of an HPLC column.

43. A method of chemiluminescence detection comprising: flowing the mobile phase and at least one reagent through the chemiluminescence detection system of any one of embodiments 21-42; and capturing the emitted light with the portable detector.

44. The method according to embodiment 43, further comprising providing chromatograms of color intensities of emitted chemiluminescence versus time.

45. The method according to embodiment 44 wherein the chromatograms comprise red-blue-green (RGB) chromatograms.

The disclosure is not to be limited to the particular embodiments described herein. The previous detailed description is of a small number of embodiments for implementing the disclosure and is not intended to be limiting in scope. The following claims set forth a number of the embodiments of the disclosure with greater particularity.

What is claimed is:

1. A flow cell comprising:
at least one channel with an inlet and an outlet configured for a mobile phase to enter the channel through the inlet and exit the channel through the outlet;
at least one LED light source; and
a fiber optic cable,
wherein the channel is exposed to the LED light source through a slit, and
wherein the fiber optic cable is positioned to capture emitted light from the mobile phase as it passes by the LED light source.

2. The flow cell according to claim 1, wherein the flow cell comprises more than one channel, more than one LED light source, and more than one fiber optic cable, wherein each channel is exposed to a separate LED light source and each fiber optic cable is positioned to capture emitted fluorescence from a separate channel.

3. The flow cell according to claim 1, wherein the channel has a width of about 0.5 mm to about 5 mm, the slit has a diameter of from about 1 mm to about 10 mm, and/or the flow cell has a rectangular top-down shape with a length and/or a width of from about 20 mm to about 100 mm.

4. The flow cell according to claim 1, further comprising a housing, wherein the housing surrounds the fuel cell and is configured to prevent light from entering the fiber optic cable and flow cell.

5. A fluorescence detection system comprising the fuel cell of claim 1 and a portable detector configured to capture a signal from the fiber optic cable, wherein the portable detector comprises a smartphone.

6. The fluorescence detection system according to claim 5, further comprising a connector box, wherein the fiber optic cable connects to the connector box and the connector box is configured to isolate the portable detector from surrounding light, and wherein the connector box fixes the distance and angle of the camera with respect to the end of the fiber optic cable.

7. The fluorescence detection system according to claim 5 wherein the mobile phase is the output of an HPLC column.

8. A method of fluorescence detection comprising:
flowing the mobile phase through the at least one channel of the flow cell according to the fluorescence detection system of claim 5; and
capturing the emitted light with the portable detector.

9. The method according to claim 8, further comprising providing chromatograms of color intensities of emitted fluorescence versus time, wherein the chromatograms comprise red-blue-green (RGB) chromatograms, and wherein separate chromatograms are provided for each channel in the flow cell.

10. A fluorescence detection kit comprising:
the flow cell according to claim 1; and a connector box.

11. A chemiluminescence detection system comprising a flow cell configured for a mobile phase and at least one reagent to enter the flow cell through an inlet and exit the flow cell through an outlet, wherein the flow cell comprises a chamber and/or a channel, and wherein the mobile phase is the output of an HPLC column.

12. The chemiluminescence detection system of claim 10, wherein the flow cell is a chamber flow cell comprising a cylindrical chamber.

13. The chemiluminescence detection system of claim 12, wherein the cylindrical chamber has an inner diameter of from about 2.5 mm to about 7.0 mm and a length of from about 2 cm to about 20 cm.

14. The chemiluminescence detection system of claim 10, wherein the system further comprises a flow cell holder configured to hold the flow cell stationary.

15. The chemiluminescence detection system of claim 10, wherein the system further comprises at least one mixer in fluid connection with the flow cell, wherein the mixer is configured to combine the mobile phase and at least one reagent prior to the inlet of the flow cell.

16. The chemiluminescence detection system of claim 15, wherein the system comprises two mixers, wherein each mixer is configured to mix the mobile phase with a separate reagent.

17. The chemiluminescence detection system of claim 10, further comprising a housing unit configured to enclose the system, wherein the housing unit is comprised of a material that is impenetrable to light.

18. The chemiluminescence detection system of claim 17, wherein the housing unit is configured to hold a portable detector stationary.

19. The chemiluminescence detection system of claim 10, further comprising a portable detector configured to capture chemiluminescence.

20. A method of chemiluminescence detection comprising: flowing the mobile phase and at least one reagent through the chemiluminescence detection system of claim 10; and capturing the emitted light with the portable detector.
